(19) United States
(12) Patent Application Publication
(10) Pub. No.: US 2026/0127153 A1
(43) Pub. Date: May 7, 2026

(54) Feature Analysis With Causal Discovery for Dataset Optimization

(71) Applicant: Howso Incorporated, Raleigh, NC (US)

(72) Inventors: Jacob Daniel Beel, Raleigh, NC (US); Bridgette Jayne Befort DeFever, Bartlesville, OK (US); Christopher James Hazard, Raleigh, NC (US); Jack Xia, Cary, NC (US)

(21) Appl. No.: 19/380,416

(22) Filed: Nov. 5, 2025

Related U.S. Application Data
(60) Provisional application No. 63/716,559, filed on Nov. 5, 2024.

(51) Int. Cl. G06F 16/22; G06F 16/26

(52) U.S. Cl. CPC G06F 16/2237; G06F 16/26

(57) ABSTRACT

The present disclosure provides systems and methods for analysis and management of complex datasets. An example method can include obtaining a dataset, evaluating one or more feature importance metrics for feature subsets to generate feature importance values, generating one or more feature importance matrices from the feature importance values, and then identifying one or more asymmetries in the feature importance matrices. The identified asymmetries can be used to generate graphical user interface visualizations to facilitate improved understanding and management of the dataset. For example, the identified asymmetries and/or generated visualization can be used for manual and/or automatic generation of feature correction actions which improve the quality of the underlying dataset. Alternatively or additionally, the identified asymmetries and/or generated visualization can be used for the identification of causal relationships in controllable systems, leading to the ability to provide improved control of controllable systems.

### PRIORITY CLAIM

This application claims priority to and the benefit of U.S. Provisional Application No. 63/716,559, filed Nov. 5, 2024. U.S. Provisional Application No. 63/716,559 is hereby incorporated by reference in its entirety.

### FIELD

The present disclosure relates to computer-based reasoning systems and more specifically to data analysis and refinement for computer-based reasoning systems.

### BACKGROUND

In the field of data analytics and machine learning, a technical challenge is the effective management and analysis of complex datasets, particularly in understanding the interactions and influences among various features within these datasets. Traditional methods often struggle to accurately quantify and visualize the relationships between different data features, especially when dealing with large volumes of data or datasets with a high degree of interconnectivity among features. For example, many traditional methods do not attempt to determine cause and effect between different data features, but instead focus exclusively on the ability to correctly predict a certain outcome or response. This limitation can lead to inefficiencies in data processing and analysis, as well as potential inaccuracies in the outcomes of predictive models. Conversely, models and techniques which do attempt to develop a better understanding of the causal relationships between features often tend to sacrifice flexibility. Thus, improved techniques are needed which enable feature analysis such as causal discovery without comprising other capabilities of the model.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method for improved feature analysis. The computer-implemented method includes obtaining, by a computing system may include one or more computing devices, a dataset may include a plurality of cases, where each of the plurality of cases has a plurality of values respectively for a plurality of features. The method also includes evaluating, by the computing system based on the dataset, a feature importance metric for a plurality of feature subsets of the plurality of features to respectively generate a plurality of feature importance values, where the feature importance value for each feature subset indicates an importance of the feature subset in predicting another feature subset. The method also includes generating, by the computing system, a feature importance matrix from the plurality of feature importance values, where the feature importance matrix may include a square matrix with row and column labels equal to the plurality of feature subsets. The method also includes identifying, by the computing system, one or more asymmetries exhibited by the feature importance matrix. Other embodiments of this aspect include corresponding computer systems, apparatus, and computer programs recorded on one or more computer storage devices, each configured to perform the actions of the methods.

Example implementations may include any combination of one or more of the following features. The computer-implemented method where the feature importance metric may include a predictive feature importance metric. The predictive feature importance metric may include a feature contribution metric. The method may further include generating, by the computing system, a graphical user interface visualization based on the asymmetries identified from the feature importance matrix. The graphical user interface visualization may include a directed graph. The directed graph may include two or more nodes that correspond to two or more of the feature subsets, and where the directed graph may include one or more directed edges that each demonstrate a directional relationship between two of the feature subsets that correspond to two of nodes, each directional relationship derived from one of the one or more asymmetries. Said steps of evaluating, generating, and identifying may be performed for each of multiple different feature importance metrics. Generating, by the computing system, the feature importance matrix from the plurality of feature importance values may include normalizing, by the computing system, the plurality of feature importance values. Normalizing, by the computing system, the plurality of feature importance values may include normalizing, by the computing system, the plurality of feature importance values by a contribution to a percentage of an overall prediction. The plurality of feature subsets may include all feature subsets contained in a superset generated from the plurality of features. The method may further include automatically generating, by the computing system, one or more feature correction actions based on the one or more asymmetries. The computer-implemented method may include providing, by the computing system, the one or more feature correction actions as an output to a user. The method may further include: identifying, by the computing system, a causal relationship between one or more of the feature subsets and a current state of a controllable system based on the one or more asymmetries; and controlling, by the computing system, the controllable system based on the causal relationship. The one or more graph structures may include one or more cliques, ergodic regions, or transitive regions. The one or more graph metrics may include one or more measurements of centrality, assortativity, or modularity. Said steps of evaluating, generating, and identifying may be performed for both a feature contributions metric and a mean decrease in accuracy metric. A computer system may be configured to perform the method. The computer-implemented method may include automatically performing, by the computing system, one or more feature correction actions on the dataset. The computer-implemented method may include, after performing the one or more feature correction actions, training or re-training, by the computing system, a machine-learned model on the dataset. Normalizing, by the computing system, the plurality of feature importance values may include normalizing, by the computing system, the plurality of feature importance values between a mean absolute deviation of the feature subset and a residual of predicting the feature subset given all of the dataset. The graphical user interface visualization may include a matrix visualization of at least a portion of the feature importance matrix, where the matrix visualization may include a visual characteristic that identifies the one or more asymmetries. The graphical user interface visualization may include a quadrant visualization that sorts at least some of the plurality of feature subsets into four quadrants, the four quadrants corresponding to: high reduction in uncertainty but low importance; low reduction in uncertainty and low importance; low reduction in uncertainty but high importance; and high reduction in uncertainty and high importance. The feature importance metric may include an uncertainty quantification metric. The uncertainty quantification metric may include a mean decrease in accuracy metric. The computer-implemented method where the plurality of feature subsets equal the plurality of features. Implementations of the described techniques may include hardware, a method or process, or computer software on a computer-accessible medium.

One general aspect includes one or more non-transitory computer-readable media that collectively store a machine-learned model that has been trained or re-trained as described herein. Other embodiments of this aspect include corresponding computer systems, apparatus, and computer programs recorded on one or more computer storage devices.

One general aspect includes a computing system for improved feature analysis, the system comprising: one or more processors; and one or more non-transitory computer-readable media storing instructions that, when executed by the one or more processors, cause the system to perform operations comprising: obtaining a dataset comprising a plurality of cases, wherein each of the plurality of cases has a plurality of values respectively for a plurality of features; for a target feature subset of a plurality of feature subsets, evaluating a feature importance value by: determining a first predictive accuracy for the target feature subset based on a first set of input features that includes the target feature subset; determining a second predictive accuracy for the target feature subset based on a second set of input features that excludes the target feature subset; and generating the feature importance value for the target feature subset based on a comparison of the first predictive accuracy and the second predictive accuracy; generating a feature importance matrix from a plurality of feature importance values evaluated for the plurality of feature subsets; and identifying one or more asymmetries exhibited by the feature importance matrix.

In some implementations, the operations further comprise: identifying, based on a magnitude of the feature importance value for the target feature subset, an indication that one or more unobserved features relevant to predicting the target feature subset are absent from the dataset. In some implementations, the operations further comprise: generating, in response to identifying the indication, a feature correction action comprising a recommendation to obtain additional data for one or more new features related to the target feature subset. In some implementations, identifying the one or more asymmetries comprises identifying a directional causal relationship between two feature subsets of the plurality of feature subsets.

One general aspect is directed to a computing system for improved feature analysis, the computing system comprising: one or more processors; and one or more non-transitory computer-readable media storing instructions that, when executed by the one or more processors, cause the system to perform operations comprising: obtaining a dataset comprising a plurality of cases, wherein each of the plurality of cases has a plurality of values respectively for a plurality of features; evaluating, for each of a plurality of feature subsets, a missing information ratio by: determining a best-case predictive accuracy for a target feature subset by predicting the target feature subset using a set of input features that includes the target feature subset; determining a standard predictive accuracy for the target feature subset by predicting the target feature subset using a set of input features that excludes the target feature subset; and generating the missing information ratio based on a comparison between the best-case predictive accuracy and the standard predictive accuracy; and identifying, based on a magnitude of the missing information ratio for the target feature subset, an indication that one or more unobserved features relevant to predicting the target feature subset are absent from the dataset.

In some implementations, the operations further comprise: generating a feature importance matrix from a plurality of missing information ratios evaluated for the plurality of feature subsets; and identifying one or more asymmetries exhibited by the feature importance matrix to identify a directional causal relationship between two of the plurality of feature subsets. In some implementations, the operations further comprise: generating, in response to identifying the indication, a feature correction action comprising a recommendation to collect additional case data for one or more new features related to the target feature subset.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a flow chart diagram of an example computer-implemented method for improved feature analysis according to example embodiments of the present disclosure.

FIG. 1B depicts an example graphical visualization of a directed graph according to example embodiments of the present disclosure.

FIG. 1C depicts an example graphical visualization of a feature importance matrix according to example embodiments of the present disclosure.

FIG. 1D depicts an example graphical visualization of a quadrant-based representation according to example embodiments of the present disclosure.

FIG. 2 depicts a block diagram of an example computing system according to example embodiments of the present disclosure.

FIG. 3 depicts a schematic diagram of an example computing system according to example embodiments of the present disclosure.

FIG. 4 depicts a flow chart diagram of an example method for controlling a controllable system according to example embodiments of the present disclosure.

### DETAILED DESCRIPTION

### Overview

Example aspects of the present disclosure are directed to computer-implemented systems and methods for analysis and management of complex datasets through the evaluation of feature interactions and influences. An example method can include obtaining a dataset, evaluating one or more feature importance metrics for feature subsets to generate feature importance values, generating one or more feature importance matrices from the feature importance values, and then identifying one or more asymmetries or other data characteristics in the feature importance matrices. As used herein, the term “feature importance” is a general term that includes or relates to any metric or measure that assesses the significance, influence, or impact of features within a dataset. This encompasses, among other things, measures of “contribution” to predictive outcomes and “uncertainty” in predictions, as is described further below. The asymmetries identified in the feature importance matrix can indicate directional influences among features. The identified asymmetries and/or other identified characteristics of the matrix can be used to automatically reason about causal relationships, which can be used for automation and automated discovery. Additionally, the identified asymmetries or other matrix characteristics can be used to generate graphical user interface visualizations to facilitate improved understanding and management of the dataset. For example, the identified asymmetries and/or generated visualization can be used for manual and/or automatic generation of feature correction actions which improve the quality of the underlying dataset. These asymmetries may also be used to provide additional insights to generate recommendations such as, but not limited to, what-if analysis, root cause analysis, and feature set modifications. The asymmetries themselves may be obtained by conditioning or asking what-if questions with regard to the data. In addition to asymmetries, other graph structures or characteristics, such as cliques, ergodic regions, transitive regions, nodes identified via transitive measures, etc. that emerge from a feature importance matrix, or combinations of multiple feature importance matrices may provide further information as to the causal structures. Alternatively or additionally, the identified asymmetries and/or other detected graph structures, along with generated visualization(s), can be used for the identification of causal relationships in controllable systems, leading to the ability to provide improved control of controllable systems.

More particularly, a computing system can obtain a dataset that comprises multiple cases, where each case includes values for various features. For instance, in a manufacturing dataset, each case might represent a production batch record, and the features could include material type, temperature settings, machine run-time, etc.

The computing system can evaluate one or more feature importance metrics for various subsets of features within the dataset. This evaluation can result in the generation of feature importance values for the feature subsets. The feature importance values can indicate the significance of each feature subset in predicting outcomes related to other feature subsets. For example, in a manufacturing dataset, the importance of features like material composition or ambient temperature might be evaluated with respect to the ability to predict product hardness.

As one example, the feature importance metric(s) that are evaluated can include predictive feature importance metrics, such as feature contribution (FC) metrics. These metrics can quantify how much each feature contributes to the outcome predictions. For example, if a first feature is used to predict a second feature that is measured in terms of gallons, a FC metric for the first feature might indicate how many gallons out of the predicted number of gallons are attributable to the first feature. In some implementations, it is additionally beneficial if the predictive feature importance metrics describe the data itself rather than a model, but if a model is sufficiently flexible to be able to compute predictive feature importance metrics using many features as targets, then it may suffice to measure the feature importances of the model.

As another example, the feature importance metric(s) that are evaluated can include uncertainty quantification metrics, such as mean decrease in accuracy (MDA) metrics. These metrics can assess how each feature contributes to prediction uncertainty by quantifying the potential increase (or decrease) in prediction errors associated with each feature. For example, in a manufacturing context, the MDA metric might measure how much uncertainty or accuracy the addition of features such as material composition or ambient temperature introduces to the ability to predict final product hardness. For example, ambient temperature may enable a 1.6% reduction in error when predicting the final product hardness.

Furthermore, in the context of data analysis and feature optimization, the relationship between uncertainty and confidence is generally inverse. For example, as uncertainty decreases within a dataset or model, the confidence in the predictions and insights derived from that dataset correspondingly increases. Thus, metrics that quantify uncertainty, such as MDA, directly contribute to understanding and enhancing the confidence levels associated with the model's outputs. Therefore, any mention of uncertainty metrics within the scope of this disclosure inherently encompasses associated confidence metrics within the scope of the present disclosure.

In addition to these predictive feature importance metrics and uncertainty quantification metrics, example implementations can also incorporate other feature importance metrics that evaluate the effects of features on various performance measures. These could include precision, recall, F1 scores, MCC, other class-imbalance adjusted scores, which assess the performance of predictive models in scenarios where certain classes are underrepresented, RMSE, MAE, Spearman's Rank Correlation, R&2, Kolmogorov-Smirnov test, ROC measurements, Mann-Whitney U test, and/or any other performance measure. Due to the flexibility of the system, other granular and custom metrics may also be used, including metrics on counterfactuals and specific conditioned subsets of the data. By integrating these metrics, the computing system can provide a more granular analysis of how individual features impact the overall effectiveness of the model.

Thus, the computing system can generate one or more multiple feature importance matrices for one or multiple feature importance metrics. The feature importance metrics can include predictive feature importance metrics such as FC metrics, uncertainty quantification metrics such as MDA, and other performance-evaluating metrics like precision, recall, F1 scores, MCC, RMSE, MAE, Spearman's Rank Correlation, R-squared, and the Kolmogorov-Smirnov test. Additionally, the system can incorporate ROC measurements, Mann-Whitney U tests, and other specialized metrics that assess the effects of features on various performance measures, including those tailored to scenarios with class imbalances or specific conditioned subsets of data. This allows the computing system to assess and visualize the impact of individual features and their interactions within the dataset across many different measures of “importance”.

In some implementations, the evaluation of each feature importance metric can be performed on either all possible combinations of features within a dataset (e.g., the superset) or on some select subset of these feature combinations. This flexibility allows for a comprehensive exploration of feature interactions when all feature subsets are included, or a more focused analysis when only specific feature subsets are considered.

After evaluating the feature importance metric(s), the computing system can generate a feature importance matrix for each evaluated metric. Specifically, the feature importance matrix for each evaluated metric can be generated from the feature importance values generated by evaluating that feature importance metric. Each feature importance matrix can be a square matrix where both the rows and columns represent the feature subsets. Such a matrix layout allows for an analysis of how different features interact and influence each other, which can be useful for analyzing complex datasets.

In some implementations, generating each feature importance matrix can include normalizing the corresponding feature importance values. This can be beneficial for comparing features on a common scale. This normalization can be done in various ways. As one example, each FC metric value might be normalized based on its contribution to the overall prediction percentage, while each MDA metric value could be normalized between the mean absolute deviation of a feature and the residual of predicting the feature with the complete dataset. Additionally, other normalization techniques may include using the feature itself for predictions or scaling the matrices by the overall impact on uncertainty, or even scaling the MDA by a function of FC, which may include using the maximum, minimum, and range of FC or MDA.

The generated matrices may, in some cases, resemble correlation heat maps, offering a visual representation of the relationships among features. However, these matrices extend beyond traditional heat maps by not being confined to linear relationships, thus providing a more accurate depiction of feature interactions. Furthermore, while these matrices are primarily symmetric across the diagonal, indicating similar mutual influences between paired features, they do often exhibit intriguing asymmetries. These asymmetries reveal directional influences and dependencies among the features. In addition to asymmetries, other graph structures or characteristics detected in the generated matrices or combinations thereof, such as cliques, ergodic regions, transitive regions, nodes identified via transitive measures, etc. may provide further information as to the causal structures.

Thus, the computing system can identify one or more asymmetries and other graph structures or characteristics within each feature importance matrix. These asymmetries and other graph structures or characteristics can indicate directional influences among feature subsets. For example, an asymmetry might show that temperature settings influence material properties, rather than vice versa.

As other examples, graph structures can also include cliques, which are subsets of features where every distinct pair of features is directly connected, indicating strong mutual influence or dependency. Ergodic regions can also be identified, where there is a high likelihood of transitioning between features within the region, suggesting interconnected dynamics or influence cycles among those features. Additionally, the system can detect transitive regions, where influence or properties transitively flow through the features, which may illustrate indirect relationships and cascading effects within the dataset.

As yet other examples, graph characteristics can include graph metrics such as, for example, measurements of centrality (e.g., eigenvector centrality, closeness centrality, percolation centrality, cross-clique centrality), assortativity, and modularity.

In some implementations, the computing system can generate one or more graphical user interface visualizations based on the identified asymmetries and/or other graph structures and/or characteristics. In particular, the matrices reveal diverse relationships within the dataset, notably through asymmetries that indicate directional flows of information concerning predictions and uncertainties (e.g., from feature subset A to feature subset B and vice versa). Graphical representations which illustrate this information can assist the user in understanding likely causal mechanisms and discrepancies between predictive and uncertainty relationships. For instance, a strong FC value with a negative MDA value suggests the necessity to gather more related features to diminish uncertainty. Conversely, features that contribute less for predictions but which are significant for resolving uncertainties indicate areas where additional data collection could be advantageous.

As one example, in some implementations, the system can generate directed graphs as part of the graphical user interface visualizations. These graphs can include nodes that represent different feature subsets of the dataset. Directed edges between these nodes can illustrate the directional relationships and influences among these feature subsets.

As another example, in some implementations, the visualization can display portions or the entirety of the matrices, incorporating visual characteristics that highlight identified asymmetries. This method of visualization allows users to easily discern and understand directional influences and interactions among features, facilitating a more intuitive grasp of complex data relationships.

As yet another example, the graphical visualizations can include quadrant visualizations that categorize feature subsets based on their impact on uncertainty reduction and their importance in predictions. On example visualization technique divides the feature subsets into four distinct quadrants, each representing a unique combination of uncertainty reduction and predictive importance. Such a categorization enables users to quickly discern which features reduce uncertainty while being significant for predictions, which are less important and reduce little uncertainty, and other variations in between.

Furthermore, matrix transformations, such as other forms of normalization, scaling, and mathematical modifications, can uncover non-transient features and identify those with maximum influence, enhancing the overall interpretability and application of the dataset across various conditions and analyses.

In some implementations, the computing system can also automatically generate feature correction actions based on the identified asymmetries. These actions can help in optimizing the dataset.

One example automatic feature correction action includes the removal of feature subsets that exhibit both low contribution to outcome predictions and low reduction in uncertainty. This action can be informed by the analysis conducted through the feature importance matrices, where feature subsets that neither significantly influence the predictive model nor reduce predictive uncertainty are identified as suboptimal.

Another example automatic feature correction action includes the use of only feature subsets that demonstrate both high contribution to outcome predictions and significant reduction in prediction uncertainty. By identifying and utilizing only these optimal feature subsets, the system enhances the efficiency and effectiveness of data analysis. This selective approach allows for a more streamlined and targeted analysis, where resources are concentrated on the most impactful and reliable data points. The dual criteria of high contribution and high reduction in uncertainty ensure that the features used are both influential in their predictive capacity and robust in their consistency, leading to improved overall performance and reliability of the system.

Another example automatic feature correction action includes the automatic refocusing of additional data collection efforts on feature subsets that demonstrate low contribution to outcome predictions but high reduction in prediction uncertainty. By collecting additional case data for these feature subsets, the system enhances the efficiency and effectiveness of the underlying dataset.

By performing these feature correction actions, the method effectively streamlines the dataset, focusing on more impactful features, which can enhance the efficiency and accuracy of the predictive models used within the system. This optimization not only simplifies data management but also improves the overall performance and reliability of the system's predictions.

As another example, for features identified to have high contribution but low reduction in uncertainty, the computing system can suggest alternative features that could potentially enhance prediction accuracy and reduce uncertainty. One possible approach can include querying a large language model to identify similar yet substantively different features for collection. For example, if a feature like “machine run-time” shows high contribution but low uncertainty reduction in a manufacturing dataset, the language model might suggest collecting data on “machine efficiency”or “maintenance frequency”as alternative features.

As another example, the proposed techniques can facilitate the identification of causal relationships in systems (e.g., controllable systems) based on the asymmetries identified in the feature importance matrix. Knowledge of these causal relationships can then be applied to improve control of the controllable system.

In particular, by identifying which features directly influence others, the computing system can pinpoint causal mechanisms that govern system behavior. This knowledge allows for more precise adjustments to the system's inputs or configurations, leading to optimized performance and outcomes. For example, in a manufacturing setting, knowing the causal relationship between machine temperature settings and material properties allows for fine-tuning of temperatures to achieve desired material characteristics. Thus, the ability to control a system based on its identified causal relationships can significantly improve operational efficiency and effectiveness, reducing errors and enhancing output quality.

In some implementations, the predictive feature importance metrics, such as FC metrics, are highly effective for identifying useful features that are strongly associated with or predictive of other features. However, a high feature importance value from this metric alone may not itself definitively establish a causal relationship, as a strong predictive association can arise from correlation or confounding variables. Rather, the primary indicators of directional, and therefore potentially causal, influence can be derived from the asymmetries identified in the feature importance matrix. The FC value can thus serve as a measure of the magnitude or strength of a feature's predictive influence, which complements the directional information revealed through matrix asymmetry.

Further, in some implementations, the analytical power of the system can be fully realized through the combined use of multiple, distinct feature importance metrics, such as evaluating both a FC metric and an uncertainty quantification metric like the MDA metric. For example, analysis of the asymmetries in an MDA-based matrix may identify a feature subset as being potentially causal (e.g., it significantly reduces prediction uncertainty), yet that same feature subset might exhibit a low FC value. The disclosed system can interpret this combination to mean that while the feature subset has a causal role, its direct contribution to the predicted outcome's magnitude is small. The FC metric can therefore serve as a valuable secondary filter, helping to characterize the strength of a causal link after its directional nature has been identified. This prevents the erroneous removal of causally-significant features during feature correction actions and leads to a more robust and accurate understanding of the underlying system.

In further implementations, the system may evaluate a specialized feature importance metric, which may be referred to as a “missing information ratio,” to quantify the impact of potentially missing or unobserved features within the dataset. This ratio provides a powerful method for estimating the contribution of information that is not present in the current set of features. One aspect of this technique is to establish a benchmark for optimal predictive accuracy and compare it against the actual accuracy achievable with the available data. The discrepancy between these two values represents the “missing information” and can be used to guide further data collection and refine causal discovery.

The evaluation of the missing information ratio for a given target feature subset can include a comparative process. First, the computing system can determine a best-case predictive accuracy. This can be achieved by evaluating the accuracy of predicting the target feature subset while temporarily including the target feature subset itself as one of the input features. This effectively simulates a scenario with “perfect information,” where the answer is known beforehand. Second, the computing system determines a standard predictive accuracy by evaluating the prediction of the same target feature subset using only the other available feature subsets as inputs (i.e., without knowing the answer). The “missing information ratio” can then be generated based on a comparison, such as the difference or a ratio, between the best-case accuracy and the standard accuracy.

In some implementations, this technique can be used for identifying and confirming causal relationships. For example, by generating a feature importance matrix populated with these ratio values, asymmetries in the matrix can reveal the direction of causality with high confidence. A significant asymmetry in the missing information ratio between two features suggests a strong directional influence. For instance, if the ratio indicates that knowing the value of Feature B provides a much greater leap in accuracy for predicting Feature A than vice-versa, it implies a stronger causal link flowing from Feature B to Feature A, as Feature B contains unique, non-reciprocal information about Feature A.

Furthermore, the absolute magnitude of the missing information ratio for a given target feature is itself a valuable diagnostic tool. A large ratio signifies that a substantial amount of predictive information is unaccounted for by the currently available features in the dataset. This can automatically trigger or recommend a feature correction action, such as prompting a user to collect additional data related to the target feature. By systematically identifying which features have the most “missing information,” the system can guide data acquisition efforts to the areas of greatest uncertainty, thereby improving the completeness of the dataset and the performance of any computer-based reasoning models trained thereon.

The systems and methods of the present disclosure provide a number of technical effects and benefits. As one example, the proposed technology improves the efficiency of data processing by enabling a more structured and accurate analysis of feature interactions within complex datasets. This is achieved through the generation of feature importance matrices which facilitate an improved understanding of how different features influence each other.

As another example, by identifying asymmetries within the feature importance matrices, the technology provides a clear visualization and quantification of directional influences among features. This assists with uncovering causal relationships and dependencies that can be used to refine predictive models.

As another example, the proposed techniques facilitate the pruning of datasets by identifying and evaluating the significance and influence of combinations of one or more features through feature importance metrics. By identifying less impactful or redundant features, the technology enables the selective removal of these features from the dataset. This targeted pruning not only reduces the overall size of the dataset, leading to decreased storage costs, but also streamlines the data processing and model training phases. Training models on pruned datasets that retain only the most significant features can significantly accelerate the training process without compromising the performance of the models.

With reference now to the FIGs., example embodiments of the present disclosure will be discussed in further detail.

### Example Method for Feature Analysis

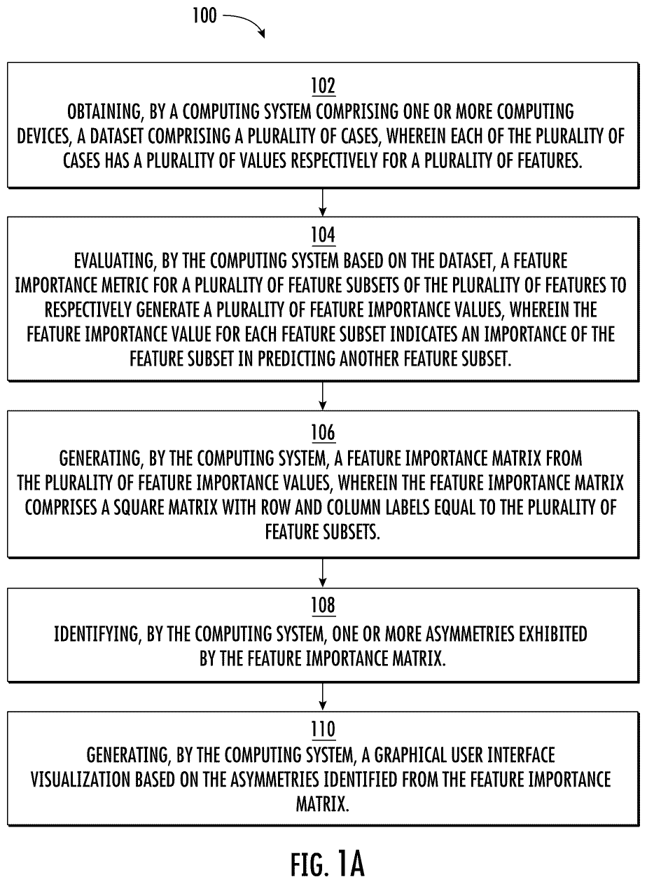

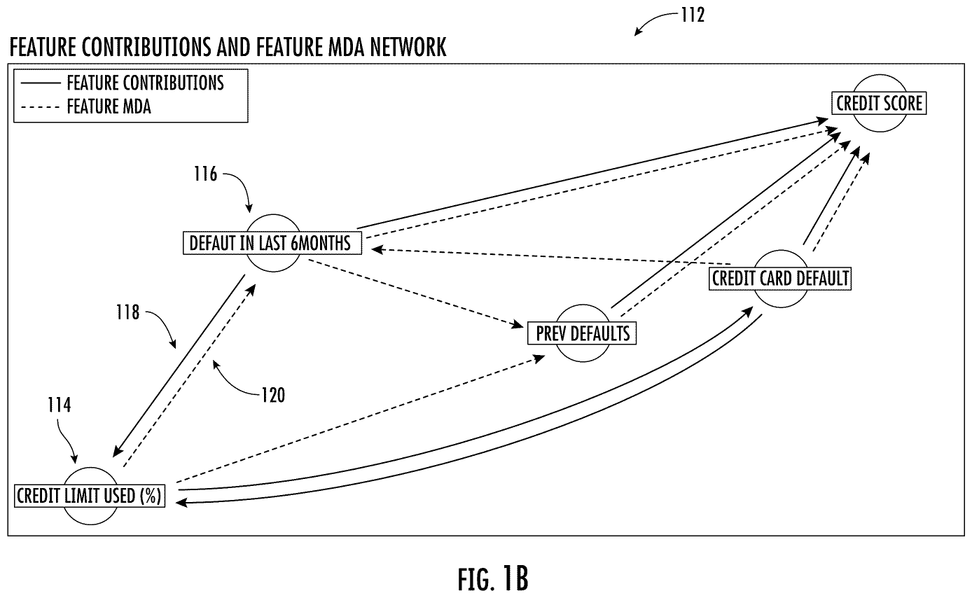

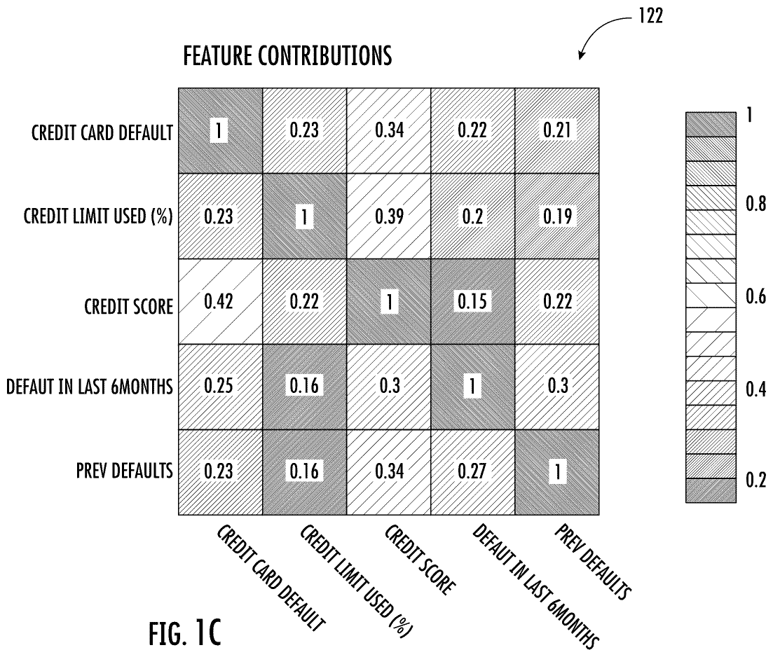

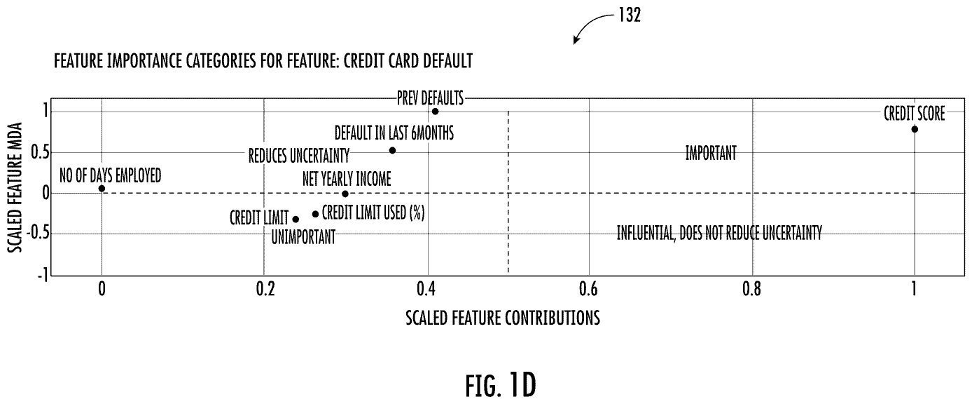

FIG. 1A depicts a flow chart diagram illustrating a computer-implemented method 100 for improved feature analysis. The method can be executed by a computing system that can include one or more computing devices.

At 102, the computing system can obtain a dataset. This dataset can comprise a plurality of cases, where each case has a plurality of values respectively for a plurality of features. An example of such a dataset could be a manufacturing dataset where each case represents a production batch record.

At 104, the computing system can evaluate a feature importance metric for a plurality of feature subsets of the plurality of features to respectively generate a plurality of feature importance values. Each feature importance value for a feature subset can indicate an importance of the feature subset in predicting another feature subset. For instance, the feature importance metric can be a predictive feature importance metric such as an FC metric or can be an uncertainty quantification metric such as mean decrease in accuracy. Other metric(s) can be evaluated additionally or alternatively.

At 106, the computing system can generate a feature importance matrix from the plurality of feature importance values. This feature importance matrix can comprise a square matrix with row and column labels equal to the plurality of feature subsets. An example of such a matrix could resemble a correlation heat map but with capabilities to show non-linear relationships as well.

At 108, the computing system can identify one or more asymmetries exhibited by the feature importance matrix. These asymmetries can indicate directional influences among feature subsets.

At 110, the computing system can generate a graphical user interface visualization based on the asymmetries identified from the feature importance matrix. This visualization can assist users in understanding the directional influences and interactions among features, facilitating a more intuitive grasp of complex data relationships. Examples of such visualizations can include directed graphs or matrix visualizations highlighting the identified asymmetries.

### Example Visualizations

As one example, FIG. 1B illustrates a graphical visualization 112 that depicts a directed graph. The graphical visualization 112 can include multiple nodes, such as node 114 and node 116, each corresponding to different feature subsets within a dataset. These nodes can represent various aspects of data, for example, node 114 might correspond to a feature subset related to credit limit usage, and node 116 might correspond to a feature subset related to defaults in the last six months.

Directed arrows, such as arrow 118 and arrow 120, are provided between the nodes, indicating directional relationships and influences among these feature subsets. For instance, arrow 118 extending from node 114 to node 116 can illustrate a directional influence where the feature subset corresponding to node 114 impacts or contributes to the feature subset corresponding to node 116. Similarly, arrow 120 can represent another directional relationship, possibly indicating a reverse influence in terms of uncertainty reduction between the same feature subsets.

This type of graphical user interface visualization, as shown in graphical visualization 112, can facilitate the identification of asymmetries and directional flows of information within the dataset, thereby assisting users in understanding the complex interactions and dependencies among various data features.

As another example, FIG. 1C depicts an example graphical visualization 122 of a feature importance matrix. This visualization 122 can display all values or just a subset of values, such as values above a threshold, values that demonstrate an asymmetry, and/or values that meet some other criteria. The visualization 122 can include visual characteristics such as color, highlighting, shading, etc. that assist the user in interpreting the data.

As a specific example, the matrix in visualization 122 is arranged as a grid with both rows and columns corresponding to different features of a dataset. In the example shown in FIG. 1C, the features include “credit_card_default”, “credit_limit_used(%)”, “credit_score”, “default_in_last_6months”, and “prev_defaults”. Each cell in the matrix represents the feature importance value between the feature corresponding to the row and the feature corresponding to the column.

Thus, the cells in visualization 122 contain numerical values that quantify the relationships between pairs of features. These values can be used to assess the influence of one feature on another within the context of a dataset. For instance, the cell at the intersection of the row “credit_card_default” and the column “credit_score” shows a value, indicating the importance of “credit_score”in predicting “credit_card_default”.

In some implementations, visualization 122 can include a color scale, as shown on the right side of FIG. 1C, which provides a visual representation of the range of values within the matrix. This scale can help in quickly identifying higher or lower values of feature importance by associating these values with specific colors.

As yet another example, FIG. 1D depicts an example quadrant-based visualization 132 that can be used to categorize feature subsets based on their impact on uncertainty reduction and their importance in predictions. The visualization 132 includes a horizontal axis labeled “Scaled Feature Contributions” and a vertical axis labeled “Scaled Feature Mean Decrease in Accuracy (MDA).” These axes divide the visualization 132 into four quadrants.

The upper right quadrant can represent feature subsets that are both important for predictions and reduce uncertainty. An example feature in this quadrant can be “credit_score.” The upper left quadrant can represent feature subsets that reduce uncertainty but are considered less important for predictions. Example features in this quadrant can include “prev_defaults” and “default_in_last_6months.”

The lower right quadrant can represent feature subsets that are important for predictions but do not significantly reduce uncertainty. The lower left quadrant can represent feature subsets that are neither significantly important for predictions nor do they reduce uncertainty.

Thus, each feature subset within the visualization 132 can be plotted as a point on the graph, where the position along the horizontal axis represents the scaled contribution of the feature to the predictions, and the position along the vertical axis represents the scaled contribution of the feature to reducing prediction uncertainty. This arrangement allows for a visual assessment of the relative importance and uncertainty reduction capabilities of each feature within a dataset.

### Example Systems For Computer-Based Reasoning Systems

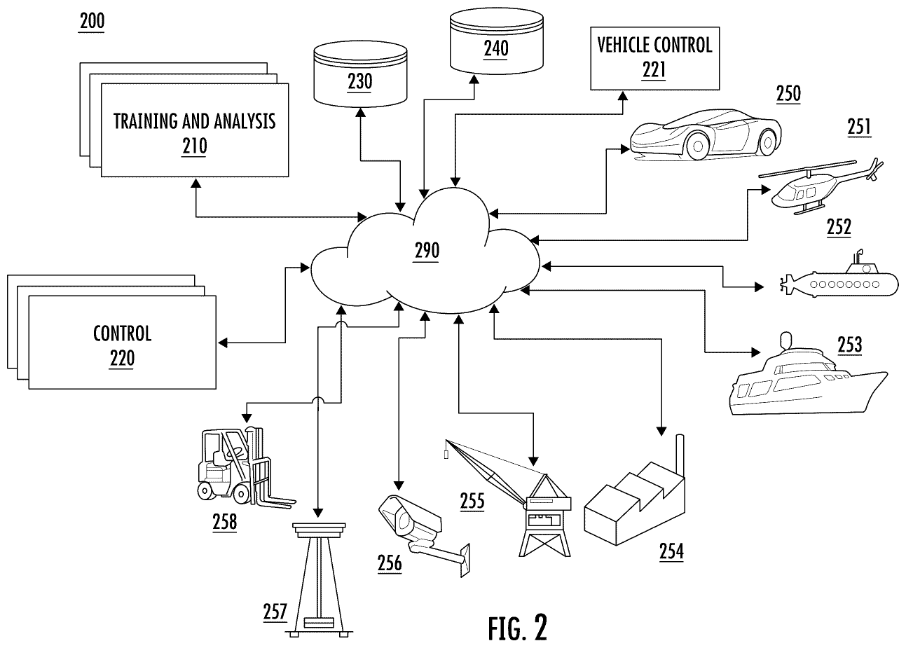

FIG. 2 is a block diagram depicting example systems for computer-based reasoning systems. Numerous devices and systems are coupled to a network 290. Network 290 can include the internet, a wide area network, a local area network, a Wi-Fi network, any other network or communication device described herein, and the like. Further, numerous of the systems and devices connected to 290 may have encrypted communication there between, VPNs, and or any other appropriate communication or security measure. System 200 includes a training and analysis system 210 coupled to network 290. The training and analysis system 210 may be used for collecting data related to systems 250-258 and creating computer-based reasoning models based on the training of those systems. Further, training and analysis system 210 may perform aspects of process 100 and/or 400 described herein. Control system 220 is also coupled to network 290. A control system 220 may control various of the systems 250-258. For example, a vehicle control 221 may control any of the vehicles 250-253, or the like. In some embodiments, there may be one or more network attached storages 230, 240. These storages 230, 240 may store training data, computer-based reasoning models, updated computer-based reasoning models, and the like. In some embodiments, training and analysis system 210 and/or control system 220 may store any needed data including computer-based reasoning models locally on the system.

FIG. 2 depicts numerous systems 250-258 that may be controlled by a control system 220 or 221. For example, automobile 250, helicopter 251, submarine 252, boat 253, factory equipment 254, construction equipment 255, security equipment 256, oil pump 257, or warehouse equipment 258 may be controlled by a control system 220 or 221.

### Example Processes for Controlling Systems

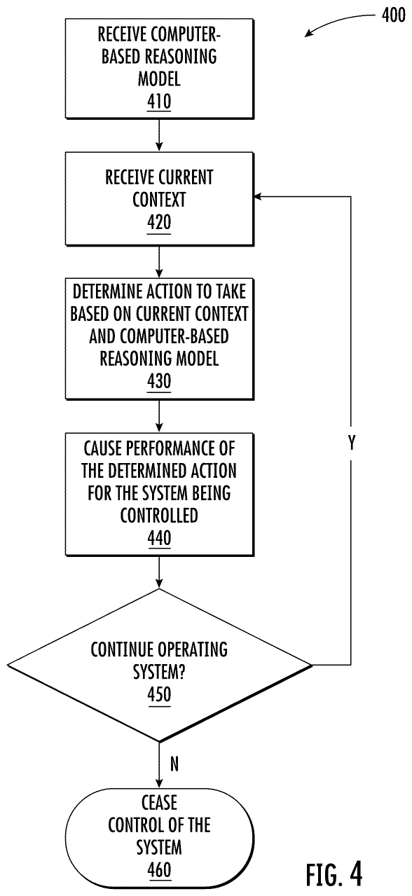

FIG. 4 depicts an example process 400 for controlling a system. In some embodiments and at a high level, the process 400 proceeds by receiving or receiving 410 a computer-based reasoning model for controlling the system. The computer-based reasoning model may be one created using or based on data generated using process 100, as one example. In some embodiments, the process 400 proceeds by receiving 420 a current context for the system, determining 430 an action to take based on the current context and the computer-based reasoning model, and causing 440 performance of the determined action (e.g., labelling an image, causing a vehicle to perform the turn, lane change, waypoint navigation, etc.). If operation of the system continues 450, then the process returns to receive 420 the current context, and otherwise discontinues 460 control of the system. In some embodiments, causing performance of a selected action may include causing 440 performance of a determined action (or vice-versa).

As discussed herein the various processes 100, 400, etc. may run in parallel, in conjunction, together, or one process may be a subprocess of another. Further, any of the processes may run on the systems or hardware discussed herein. The features and steps of processes 100, 400 could be used in combination and/or in different orders.

### Self-Driving Vehicles

Returning to the top of the process 400, it begins by receiving 410 a computer-based reasoning model for controlling or causing control of the system. The computer-based reasoning model may be received in any appropriate matter. It may be provided via a network 290, placed in a shared or accessible memory on either the training and analysis system 210 or control system 220, or in accessible storage, such as storage 230 or 240.

In some embodiments (not depicted in FIG. 4), an operational situation could be indicated for the system. The operational situation is related to context, but may be considered a higher level, and may not change (or change less frequently) during operation of the system. For example, in the context of control of a vehicle, the operational situation may be indicated by a passenger or operator of the vehicle, by a configuration file, a setting, and/or the like. For example, a passenger Alicia may select “drive like Alicia” in order to have the vehicle driver like her. As another example, a fleet of helicopters may have a configuration file set to operate like Bob. In some embodiments, the operational situation may be detected. For example, the vehicle may detect that it is operating in a particular location (area, city, region, state, or country), time of day, weather condition, etc. and the vehicle may be indicated to drive in a manner appropriate for that operational situation.

The operational situation, whether detected, indicated by passenger, etc., may be changed during operation of the vehicle. For example, a passenger may first indicate that she would like the vehicle to drive cautiously (e.g., like Alicia), and then realize that she is running later and switch to a faster operation mode (e.g., like Carole). The operational situation may also change based on detection. For example, if a vehicle is operating under an operational situation for a particular portion of road, and detects that it has left that portion of road, it may automatically switch to an operational situation appropriate for its location (e.g., for that city), may revert to a default operation (e.g., a baseline program that operates the vehicle) or operational situation (e.g., the last used). In some embodiments, if the vehicle detects that it needs to change operational situations, it may prompt a passenger or operator to choose a new operational situation.

In some embodiments, the computer-based reasoning model is received before process 400 begins (not depicted in FIG. 4), and the process begins by receiving 420 the current context. For example, the computer-based reasoning model may already be loaded into a controller 220 and the process 400 begins by receiving 420 the current context for the system being controlled. In some embodiments, referring to FIG. 2, the current context for a system to be controlled (not depicted in FIG. 2) may be sent to control system 220 and control system 220 may receive 420 current context for the system.

Receiving 420 current context may include receiving the context data needed for a determination to be made using the computer-based reasoning model. For example, turning to the vehicular example, receiving 420 the current context may, in various embodiments, include receiving information from sensors on or near the vehicle, determining information based on location or other sensor information, accessing data about the vehicle or location, etc. For example, the vehicle may have numerous sensors related to the vehicle and its operation, such as one or more of each of the following: speed sensors, tire pressure monitors, fuel gauges, compasses, global positioning systems (GPS), RADARs, LiDARs, cameras, barometers, thermal sensors, accelerometers, strain gauges, noise/sound measurement systems, etc. Current context may also include information determined based on sensor data. For example, the time to impact with the closest object may be determined based on distance calculations from RADAR or LiDAR data, and/or may be determined based on depth-from-stereo information from cameras on the vehicle. Context may include characteristics of the sensors, such as the distance a RADAR or LiDAR is capable of detecting, resolution and focal length of the cameras, etc. Context may include information about the vehicle not from a sensor. For example, the weight of the vehicle, acceleration, deceleration, and turning or maneuverability information may be known for the vehicle and may be part of the context information. Additionally, context may include information about the location, including road condition, wind direction and strength, weather, visibility, traffic data, road layout, etc.

Referring back to the example of vehicle control rules for Bob flying a helicopter, the context data for a later flight of the helicopter using the vehicle control rules based on Bob's operation of the helicopter may include fuel remaining, distance that fuel can allow the helicopter to travel, location including elevation, wind speed and direction, visibility, location and type of sensors as well as the sensor data, time to impact with the N closest objects, maneuverability and speed control information, etc. Returning to the stop sign example, whether using vehicle control rules based on Alicia or Carole, the context may include LiDAR, RADAR, camera and other sensor data, location information, weight of the vehicle, road condition and weather information, braking information for the vehicle, etc.

The control system then determined 430 an action to take based on the current context and the computer-based reasoning model. For example, turning to the vehicular example, an action to take is determined 430 based on the current context and the vehicle control rules for the current operational situation. In some embodiments that use machine learning, the vehicle control rules may be in the form of a neural network (as described elsewhere herein), and the context may be fed into the neural network to determine an action to take. In embodiments using case-based reasoning, the set of context-action pairs closest (or most similar) to the current context may be determined. In some embodiments, only the closest context-action pair is determined, and the action associated with that context-action pair is the determined 430 action. In some embodiments, multiple context-action pairs are determined 430. For example, the N “closest” context-action pairs may be determined 430, and either as part of the determining 430, or later as part of the causing 440 performance of the action, choices may be made on the action to take based on the N closest context-action pairs, where “distance” for between the current context can be measured using any appropriate technique, including use of Euclidean distance, Minkowski distance, Damerau-Levenshtein distance, Kullback-Leibler divergence, and/or any other distance measure, metric, pseudometric, premetric, index, or the like.

In some embodiments, the actions to be taken may be blended based on the action of each context-action pair, with invalid (e.g., impossible or dangerous) outcomes being discarded. A choice can also be made among the N context-action pairs chosen based on criteria such as choosing to use the same or different operator context-action pair from the last determined action. For example, in an embodiment where there are context-action pair sets from multiple operators in the vehicle control rules, the choice of which context-action pair may be based on whether a context-action pair from the same operator was just chosen (e.g., to maintain consistency). The choice among the top N context-action pairs may also be made by choosing at random, mixing portions of the actions together, choosing based on a voting mechanism, etc.

Some embodiments include detecting gaps in the training data and/or vehicle control rules and indicating those during operation of the vehicle (for example, via prompt and/or spoken or graphical user interface) or offline (for example, in a report, on a graphical display, etc.) to indicate what additional training is needed (not depicted in FIG. 4). In some embodiments, when the computer-based reasoning system does not find context “close enough” to the current context to make a confident decision on an action to take, it may indicate this and suggest that an operator might take manual control of the vehicle, and that operation of the vehicle may provide additional context and action data for the computer-based reasoning system. Additionally, in some embodiments, an operator may indicate to a vehicle that she would like to take manual control to either override the computer-based reasoning system or replace the training data. These two scenarios may differ by whether the data (for example, context-action pairs) for the operational scenario are ignored for this time period, or whether they are replaced.

In some embodiments, the operational situation may be chosen based on a confidence measure indicating confidence in candidate actions to take from two (or more) different sets of control rules (not depicted in FIG. 4). Consider a first operational situation associated with a first set of vehicle control rules (e.g., with significant training from Alicia driving on highways) and a second operational situation associated with a second set of vehicle control rules (e.g., with significant training from Carole driving on rural roads). Candidate actions and associated confidences may be determined for each of the sets of vehicle control rules based on the context. The determined 430 action to take may then be selected as the action associated with the higher confidence level. For example, when the vehicle is driving on the highway, the actions from the vehicle control rules associated with Alicia may have a higher confidence, and therefore be chosen. When the vehicle is on rural roads, the actions from the vehicle control rules associated with Carole may have higher confidence and therefore be chosen. Relatedly, in some embodiments, a set of vehicle control rules may be hierarchical, and actions to take may be propagated from lower levels in the hierarchy to high levels, and the choice among actions to take propagated from the lower levels may be made on confidence associated with each of those chosen actions. The confidence can be based on any appropriate confidence calculation including, in some embodiments, determining how much “extra information”in the vehicle control rules is associated with that action in that context.

In some embodiments, there may be a background or baseline operational program that is used when the computer-based reasoning system does not have sufficient data to make a decision on what action to take (not depicted in FIG. 4). For example, if in a set of vehicle control rules, there is no matching context or there is not a matching context that is close enough to the current context, then the background program may be used. If none of the training data from Alicia included what to do when crossing railroad tracks, and railroad tracks are encountered in later operation of the vehicle, then the system may fall back on the baseline operational program to handle the traversal of the railroad tracks. In some embodiments, the baseline model is a computer-based reasoning system, in which case context-action pairs from the baseline model may be removed when new training data is added. In some embodiments, the baseline model is an executive driving engine which takes over control of the vehicle operation when there are no matching contexts in the vehicle control rules (e.g., in the case of a context-based reasoning system, there might be no context-action pairs that are sufficiently “close”).

In some embodiments, determining 430 an action to take based on the context can include determining whether vehicle maintenance is needed. As described elsewhere herein, the context may include wear and/or timing related to components of the vehicle, and a message related to maintenance may be determined based on the wear or timing. The message may indicate that maintenance may be needed or recommended (e.g., because preventative maintenance is often performed in the timing or wear context, because issues have been reported or detected with components in the timing or wear context, etc.). The message may be sent to or displayed for a vehicle operator (such as a fleet management service) and/or a passenger. For example, in the context of an automobile with sixty thousand miles, the message sent to a fleet maintenance system may include an indication that a timing belt may need to be replaced in order to avoid a P percent chance that the belt will break in the next five thousand miles (where the predictive information may be based on previously-collected context and action data, as described elsewhere herein). When the automobile reaches ninety thousand miles and assuming the belt has not been changed, the message may include that the chance that the belt will break has increased to, e.g., P*4 in the next five thousand miles.

Performance of the determined 430 action is then caused 440. Turning to the vehicular example, causing 440 performance of the action may include direct control of the vehicle and/or sending a message to a system, device, or interface that can control the vehicle. The action sent to control the vehicle may also be translated before it is used to control the vehicle. For example, the action determined 430 may be to navigate to a particular waypoint. In such an embodiment, causing 440 performance of the action may include sending the waypoint to a navigation system, and the navigation system may then, in turn, control the vehicle on a finer-grained level. In other embodiments, the determined 430 action may be to switch lanes, and that instruction may be sent to a control system that would enable the car to change the lane as directed. In yet other embodiments, the action determined 430 may be lower-level (e.g., accelerate or decelerate, turn 4° to the left, etc.), and causing 440 performance of the action may include sending the action to be performed to a control of the vehicle, or controlling the vehicle directly. In some embodiments, causing 440 performance of the action includes sending one or more messages for interpretation and/or display. In some embodiments, the causing 440 the action includes indicating the action to be taken at one or more levels of a control hierarchy for a vehicle. Examples of control hierarchies are given elsewhere herein.

Some embodiments include detecting anomalous actions taken or caused 440 to be taken. These anomalous actions may be signaled by an operator or passenger, or may be detected after operation of the vehicle (e.g., by reviewing log files, external reports, etc.). For example, a passenger of a vehicle may indicate that an undesirable maneuver was made by the vehicle (e.g., turning left from the right lane of a 2-lane road) or log files may be reviewed if the vehicle was in an accident. Once the anomaly is detected, the portion of the vehicle control rules (e.g., context-action pair(s)) related to the anomalous action can be determined. If it is determined that the context-action pair(s) are responsible for the anomalous action, then those context-action pairs can be removed or replaced using the techniques herein.

Referring to the example of the helicopter fleet and the vehicle control rules associated with Bob, the vehicle control 220 may determine 430 what action to take for the helicopter based on the received 420 context. The vehicle control 220 may then cause the helicopter to perform the determined action, for example, by sending instructions related to the action to the appropriate controls in the helicopter. In the driving example, the vehicle control 220 may determine 430 what action to take based on the context of vehicle. The vehicle control may then cause 440 performance of the determined 430 action by the automobile by sending instructions to control elements on the vehicle.

If there are more 450 contexts for which to determine actions for the operation of the system, then the process 400 returns to receive 410 more current contexts. Otherwise, process 400 ceases 460 control of the system. Turning to the vehicular example, as long as there is a continuation of operation of the vehicle using the vehicle control rules, the process 400 returns to receive 420 the subsequent current context for the vehicle. If the operational situation changes (e.g., the automobile is no longer on the stretch of road associated with the operational situation, a passenger indicates a new operational situation, etc.), then the process returns to determine the new operational situation. If the vehicle is no longer operating under vehicle control rules (e.g., it arrived at its destination, a passenger took over manual control, etc.), then the process 400 will discontinue 460 autonomous control of the vehicle.

Many of the examples discussed herein for vehicles discuss self-driving automobiles. As depicted in FIG. 2, numerous types of vehicles can be controlled. For example, a helicopter 152 or drone, a submarine 252, or boat or freight ship 253, or any other type of vehicle such as plane or drone (not depicted in FIG. 2), construction equipment, (not depicted in FIG. 2), and/or the like. In each case, the computer-based reasoning model may differ, including using different features, using different techniques described herein, etc. Further, the context of each type of vehicle may differ. Flying vehicles may need context data such as weight, lift, drag, fuel remaining, distance remaining given fuel, windspeed, visibility, etc. Floating vehicles, such as boats, freight vessels, submarines, and the like may have context data such as buoyancy, drag, propulsion capabilities, speed of currents, a measure of the choppiness of the water, fuel remaining, distance capability remaining given fuel, and the like. Manufacturing and other equipment may have as context width of area traversing, turn radius of the vehicle, speed capabilities, towing/lifting capabilities, and the like.

### Image Labelling

The techniques herein may also be used for image-labeling systems. For example, numerous experts may label images (e.g., identifying features of or elements within those images). For example, the human experts may identify cancerous masses on x-rays. Having these experts label all input images is incredibly time consuming to do on an ongoing basis, in addition to being expensive (paying the experts). The techniques herein may be used to train an image-labeling computer-based reasoning model based on previously-trained images. Once the image-labeling computer-based reasoning system has been built, then input images may be analyzed using the image-based reasoning system. In order to build the image-labeling computer-based reasoning system, images may be labeled by experts and used as training data. Using the techniques herein, the surprisal and/or conviction of the training data can be used to build an image-labeling computer-based reasoning system that balances the size of the computer-based reasoning model with the information that each additional image (or set of images) with associated labels provides. Once the image-labelling computer-based reasoning is trained, it can be used to label images in the future. For example, a new image may come in, the image-labelling computer-based reasoning may determine one or more labels for the image, and then the one or more labels may then be applied to the image. Thus, these images can be labeled automatically, saving the time and expense related to having experts label the images.

In some embodiments, processes 100, 400 may include determining the surprisal and/or conviction of each image (or multiple images) and the associated labels or of the aspects of the computer-based reasoning model. The surprisal and/or conviction for the one or more images may be determined and a determination may be made whether to select or include the one or more images (or aspects) in the image-labeling computer-based reasoning model based on the determined surprisal and/or conviction. While there are more sets of one or more images with labels to assess, the process may return to determine whether more image or label sets should be included or whether aspects should be included and/or changed in the model. Once there are no more images or aspects to consider, the process can turn to controlling the image analysis system using the image-labeling computer-based reasoning.

In some embodiments, process 100 may determine (e.g., in response to a request) an improved dataset for use in the image-labeling computer-based reasoning model. Based on a model that uses the improved dataset, the process can cause control of an image-labeling system using process 400. For example, if the data elements are related to images and labels applied to those images, then the image-labeling computer-based reasoning model trained on that data will apply labels to incoming images. Process 400 proceeds by receiving 410 an image-labeling computer-based reasoning model. The process proceeds by receiving 420 an image for labeling. The image-labeling computer-based reasoning model is then used to determine 430 labels for the input image. The image is then labeled 440. If there are more 450 images to label, then the system returns to receive 410 those images and otherwise ceases 460. In such embodiments, the image-labeling computer-based reasoning model may be used to select labels based on which training image is “closest” (or most similar) to the incoming image. The label(s) associated with that image will then be selected to apply to the incoming image.

### Manufacturing and Assembly

The processes 100, 400 may also be used for manufacturing and/or assembly. For example, conviction can be used to identify normal behavior versus anomalous behavior of such equipment. Using the techniques herein, a crane (e.g., crane 255 of FIG. 2), robot arm, or other actuator is attempting to “grab” something and its surprisal is too high, it can stop, sound an alarm, shutdown certain areas of the facility, and/or request for human assistance. Anomalous behavior that is detected via conviction among sensors and actuators can be used to detect when there is some sort breakdown, unusual wear or mechanical or other malfunction, etc. It can also be used to find damaged equipment for repairs or buffing or other improvements for any robots or other machines that are searching and correcting defects in products or themselves (e.g., fixing a broken wire or smoothing out cuts made to the ends of a manufactured artifact made via an extrusion process). Conviction can also be used for cranes and other grabbing devices to find which cargo or items are closest matches to what is needed. Conviction can be used to drastically reduce the amount of time to train a robot to perform a new task for a new product or custom order, because the robot will indicate the aspects of the process it does not understand and direct training towards those areas and away from things it has already learned. Combining this with stopping ongoing actions when an anomalous situation is detected would also allow a robot to begin performing work before it is fully done training, the same way that a human apprentice may help out someone experienced while the apprentice is learning the job. Conviction can also inform what features or inputs to the robot are useful and which are not.

As an additional example in the manufacturing or assembly context, vibration data can be used to diagnose (or predict) issues with equipment. In some embodiments, the training data for the computer-based reasoning system would be vibration data (e.g., the output of one or more piezo vibration sensors attached to one or more pieces of manufacturing equipment) for a piece of equipment along with diagnosis of an issue or error that occurred with the equipment. The training data may similarly include vibration data for the manufacturing equipment that is not associated with an issue or error with the equipment. In subsequent operation of the same or similar equipment, the vibration data can be collected, and the computer-based reasoning model can be used to assess that vibration data to either diagnose or predict potential issues or errors with the equipment. For example, the vibration data for current (or recent) operation of one or more pieces of equipment, the computer-based reasoning model may be used to predict, diagnose, or otherwise determine issues or errors with the equipment. As a more specific example, a current context of vibration data for one or more pieces of manufacturing equipment may result in a diagnosis or prediction of various conditions, including, but not limited to: looseness of a piece of equipment (e.g., a loose screw), an imbalance on a rotating element (e.g., grime collected on a rotating wheel), misalignment or shaft runout (e.g., machine shafts may be out of alignment or not parallel), wear (e.g., ball or roller bearings, drive belts or gears become worn, they might cause vibration). As a further example, misalignment can be caused during assembly or develop over time, due to thermal expansion, components shifting or improper reassembly after maintenance. When a roller or ball bearing becomes pitted, for instance, the rollers or ball bearing will cause a vibration each time there is contact at the damaged area. A gear tooth that is heavily chipped or worn, or a drive belt that is breaking down, can also produce vibration. Diagnosis or prediction of the issue or error can be made based on the current or recent vibration data, and a computer-based reasoning model training data from the previous vibration data and associated issues or errors. Diagnosing or predicting the issues of vibration can be especially important where the vibration can cause other issues. For example, wear on a bearing may cause a vibration that then loosens another piece of equipment, which then can cause other issues and damage to equipment, failure of equipment, and even failure of the assembly or manufacturing process.

In some embodiments, techniques herein may determine (e.g., in response to a request) the surprisal and/or conviction of one or more data elements (e.g., of the manufacturing equipment) or aspects (e.g., features of context-action pairs or aspects of the model) to potentially include in the manufacturing control computer-based reasoning model. The surprisal and/or conviction for the one or more manufacturing elements may be determined and a determination may be made whether to select or include the one or more manufacturing data elements or aspects in the manufacturing control computer-based reasoning model based on the determined surprisal and/or conviction. While there are more sets of one or more manufacturing data elements or aspects to assess (e.g., from additional equipment and/or from subsequent time periods), the process may return to determine whether more manufacturing data elements or aspects sets should be included in the computer-based reasoning model. Once there are no more manufacturing data elements or aspects to consider for inclusion, the process can turn to controlling or causing control of the manufacturing system using the manufacturing control computer-based reasoning system.

In some embodiments, process 100 may determine (e.g., in response to a request) an improved dataset for use in the manufacturing control computer-based reasoning model. Based on a model using the improved data, causing control of a manufacturing system may be accomplished by process 400. For example, if the data elements are related to manufacturing data elements or aspects, then the manufacturing control computer-based reasoning model trained on that data will cause control manufacturing or assemble. Process 400 proceeds by receiving 410 a manufacturing control computer-based reasoning model. The process proceeds by receiving 420 a context. The manufacturing control computer-based reasoning model is then used to determine 430 an action to take. The action is then performed by the control system (e.g., caused by the manufacturing control computer-based reasoning system). If there are more 450 contexts to consider, then the system returns to receive 410 those contexts and otherwise ceases 460. In such embodiments, the manufacturing control computer-based reasoning model may be used to control a manufacturing system. The chosen actions are then performed by a control system.

### Smart Voice Control

The processes 100, 400 may be used for smart voice control. For example, combining multiple inputs and forms of analysis, the techniques herein can recognize if there is something unusual about a voice control request. For example, if a request is to purchase a high-priced item or unlock a door, but the calendar and synchronized devices indicate that the family is out of town, it could send a request to the person's phone before confirming the order or action; it could be that an intruder has recorded someone's voice in the family or has used artificial intelligence software to create a message and has broken in. It can detect other anomalies for security or for devices activating at unusual times, possibly indicating some mechanical failure, electronics failure, or someone in the house using things abnormally (e.g., a child frequently leaving the refrigerator door open for long durations). Combined with other natural language processing techniques beyond sentiment analysis, such as vocal distress, a smart voice device can recognize that something is different and ask, improving the person's experience and improving the seamlessness of the device into the person's life, perhaps playing music, adjusting lighting, or HVAC, or other controls. The level of confidence provided by conviction can also be used to train a smart voice device more quickly as it can ask questions about aspects of its use that it has the least knowledge about. For example: “I noticed usually at night, but also some days, you turn the temperature down in what situations should I turn the temperature down? What other inputs (features) should I consider?”

Using the techniques herein, a smart voice device may also be able to learn things it otherwise may not be able to. For example, if the smart voice device is looking for common patterns in any of the aforementioned actions or purchases and the conviction drops below a certain threshold, it can ask the person if it should take on a particular action or additional autonomy without prompting, such as “It looks like you're normally changing the thermostat to colder on days when you have your exercise class, but not on days when it is cancelled; should I do this from now on and prepare the temperature to your liking?”

In some embodiments, processes 100, 400 may include determining (e.g., in response to a request) the surprisal and/or conviction of one or more data elements (e.g., of the smart voice system) or aspects (e.g., features of the data or parameters of the model) to potentially include in the smart voice system control computer-based reasoning model. The surprisal for the one or more smart voice system data elements or aspects may be determined and a determination may be made whether to include the one or more smart voice system data elements or aspects in the smart voice system control computer-based reasoning model based on the determined surprisal and/or conviction. While there are more sets of one or more smart voice system data elements or aspects to assess, the process may return to determine whether more smart voice system data elements or aspects sets should be included. Once there are no more smart voice system data elements or aspects to consider, the process can turn to controlling or causing control of the smart voice system using the smart voice system control computer-based reasoning model.

In some embodiments, process 100 may determine (e.g., in response to a request) an improved dataset for use in the smart voice computer-based reasoning model. Based on a model that uses the improved dataset, the process can cause control of a smart voice system using process 400. For example, if the data elements are related to smart voice system actions, then the smart voice system control computer-based reasoning model trained on that data will control smart voice systems. Process 400 proceeds by receiving 410 a smart voice computer-based reasoning model. The process proceeds by receiving 420 a context. The smart voice computer-based reasoning model is then used to determine 430 an action to take. The action is then performed by the control system (e.g., caused by the smart voice computer-based reasoning system). If there are more 450 contexts to consider, then the system returns to receive 410 those contexts and otherwise ceases 460. In such embodiments, the smart voice computer-based reasoning model may be used to control a smart voice system. The chosen actions are then performed by a control system.

### Control of Federarted Devices

The processes 100, 400 may also be used for federated device systems. For example, combining multiple inputs and forms of analysis, the techniques herein can recognize if there is something that should trigger action based on the state of the federated devices. For example, if the training data includes actions normally taken and/or statuses of federated devices, then an action to take could be an often-taken action in the certain (or related contexts). For example, in the context of a smart home with interconnected heating, cooling, appliances, lights, locks, etc., the training data could be what a particular user does at certain times of day and/or in particular sequences. For example, if, in a house, the lights in the kitchen are normally turned off after the stove has been off for over an hour and the dishwasher has been started, then when that context again occurs, but the kitchen light has not been turned off, the computer-based reasoning system may cause an action to be taken in the smart home federated systems, such as prompting (e.g., audio) whether the user of the system would like the kitchen lights to be turned off. As another example, training data may indicate that a user sets the house alarm and locks the door upon leaving the house (e.g., as detected via geofence). If the user leaves the geofenced location of the house and has not yet locked the door and/or set the alarm, the computer-based reasoning system may cause performance of an action such as inquiring whether it should lock the door and/or set an alarm. As yet another example, in the security context, the control may be for turning on/off cameras, or enact other security measures, such as sounding alarms, locking doors, or even releasing drones and the like. Training data may include previous logs and sensor data, door or window alarm data, time of day, security footage, etc. and when security measure were (or should have been) taken. For example, a context such as particular window alarm data for a particular basement window coupled with other data may be associated with an action of sounding an alarm, and when a context occurs related to that context, an alarm may be sounded.

In some embodiments, processes 100, 400 may include determining the surprisal and/or conviction of one or more data elements or aspects of the federated device control system for potential inclusion in the federated device control computer-based reasoning model. The surprisal for the one or more federated device control system data elements may be determined and a determination may be made whether to select or include the one or more federated device control system data elements in the federated device control computer-based reasoning model based on the determined surprisal and/or conviction. While there are more sets of one or more federated device control system data elements or aspects to assess, the process may return to determine whether more federated device control system data elements or aspect sets should be included. Once there are no more federated device control system data elements or aspects to consider, the process can turn to controlling or causing control of the federated device control system using the federated device control computer-based reasoning model.

In some embodiments, process 100 may determine (e.g., in response to a request) an improved dataset for use in the federated device computer-based reasoning model. Based on a model that uses the improved dataset, the process can cause control of a federated device system using process 400. For example, if the data elements are related to federated device system actions, then the federated device control computer-based reasoning model trained on that data will control federated device control system. Process 400 proceeds by receiving 410 a federated device control computer-based reasoning model. The process proceeds by receiving 420 a context. The federated device control computer-based reasoning model is then used to determine 430 an action to take. The action is then performed by the control system (e.g., caused by the federated device control computer-based reasoning system). If there are more 450 contexts to consider, then the system returns to receive 410 those contexts and otherwise ceases 460. In such embodiments, the federated device control computer-based reasoning model may be used to control federated devices. The chosen actions are then performed by a control system.

### Control and Automation of Experiments

The processes 100, 400 may also be used to control laboratory experiments. For example, many lab experiments today, especially in the biological and life sciences, but also in agriculture, pharmaceuticals, materials science and other fields, yield combinatorial increases, in terms of numbers, of possibilities and results. The fields of design of experiment, as well as many combinatorial search and exploration techniques are currently combined with statistical analysis. However, conviction-based techniques such as those herein can be used to guide a search for knowledge, especially if combined with utility or fitness functions. Automated lab experiments (including pharmaceuticals, biological and life sciences, material science, etc.) may have actuators and may put different chemicals, samples, or parts in different combinations and put them under different circumstances. Using conviction to guide the machines enables them to home in on learning how the system under study responds to different scenarios, and, for example, searching areas of greatest uncertainty (e.g., the areas with low conviction as discussed herein). Conceptually speaking, when the conviction or surprisal is combined with a fitness, utility, or value function, especially in a multiplicative fashion, then the combination is a powerful information theoretic approach to the classic exploration vs exploitation trade-offs that are made in search processes from artificial intelligence to science to engineering. Additionally, such a system can automate experiments where it can predict the most effective approach, homing in on the best possible, predictable outcomes for a specific knowledge base. Further, like in the other embodiments discussed herein, it could indicate (e.g., raise alarms) to human operators when the results are anomalous, or even tell which features being measured are most useful (so that they can be appropriately measured) or when measurements are not sufficient to characterize the outcomes. This is discussed extensively elsewhere herein. If the system has multiple kinds of sensors that have “costs” (e.g., monetary, time, computation, etc.) or cannot be all activated simultaneously, the feature entropies or convictions could be used to activate or deactivate the sensors to reduce costs or improve the distinguishability of the experimental results.

In the context of agriculture, growers may experiment with various treatments (plant species or varietals, crop types, seed planting densities, seed spacings, fertilizer types and densities, etc.) in order to improve yield and/or reduce cost. In comparing the effects of different practices (treatments), experimenters or growers need to know if the effects observed in the crop or in the field are simply a product of the natural variation that occurs in every ecological system, or whether those changes are truly a result of the new treatments. In order to ameliorate the confusion caused by overlapping crop, treatment, and field effects, different design types can be used (e.g., demonstration strip, replication control or measurement, randomized block, split plot, factorial design, etc.). Regardless, however, of the type of test design type used, determination of what treatment(s) to use is crucial to success. Using the techniques herein to guide treatment selection (and possible design type) enables experimenters and growers to home in on how the system under study responds to different treatments and treatment types, and, for example, searching areas of greatest uncertainty in the “treatment space” (e.g., what are the types of treatments about which little is known?). Conceptually, the combination of conviction or surprisal with a value, utility, or fitness function such as yield, cost, or a function of yield and cost, become a powerful information theoretic approach to the classic exploration vs exploitation trade-offs that are made in search processes from artificial intelligence to science to engineering. Growers can use this information to choose treatments balancing exploitation (e.g., doing things similar to what has produced high yields previously) and exploration (e.g., trying treatments unlike previous ones, with yet-unknown results). Additionally, the techniques can automate experiments on treatments (either in selection of treatments, designs, or robotic or automated planting using the techniques described herein) where it can predict the most effective approach, and automatically perform the planting or other distribution (e.g., of fertilizer, seed, etc.) required of to perform the treatment. Further, like in the other embodiments discussed herein, it could indicate (e.g., raise alarms) to human operators when the results are anomalous, or even tell which features being measured are most useful or when measurements are not useful to characterize the outcomes (e.g., and may possibly be discarded or no longer measured). If the system has types of sensors (e.g., soil moisture, nitrogen levels, sun exposure) that have “costs” (e.g., monetary, time, computation, etc.) or cannot be all collected or activated simultaneously, the feature entropies or convictions could be used to activate or deactivate the sensors to reduce costs while protecting the usefulness of the experimental results.

In some embodiments, processes 100, 400 may include determining (e.g., in response to a request) the surprisal and/or conviction of one or more data elements or aspects of the experiment control system. The surprisal for the one or more experiment control system data elements or aspects may be determined and a determination may be made whether to select or include the one or more experiment control system data elements or aspects in an experiment control computer-based reasoning model based on the determined surprisal and/or conviction. While there are more sets of one or more experiment control system data elements or aspects to assess, the process may return to determine whether more experiment control system data elements or aspects sets should be included. Once there are no more experiment control system data elements or aspects to consider, the process can cause control of the experiment control system using the experiment control computer-based reasoning model.

In some embodiments, process 100 may determine (e.g., in response to a request) an improved dataset for use in the experiment control computer-based reasoning model. Based on a model that uses the improved dataset, the process can cause control of an experiment control system using process 400. For example, if the data elements are related to experiment control system actions, then the experiment control computer-based reasoning model trained on that data will control experiment control system. Process 400 proceeds by receiving 410 an experiment control computer-based reasoning model. The process proceeds by receiving 420 a context. The experiment control computer-based reasoning model is then used to determine 430 an action to take. The action is then performed by the control system (e.g., caused by the experiment control computer-based reasoning system). If there are more 450 contexts to consider, then the system returns to receive 410 those contexts and otherwise ceases 460. In such embodiments, the experiment control computer-based reasoning model may be used to control experiment. The chosen actions are then performed by a control system.

### Control of Energy Transfer Systems

The processes 100, 400 may also be used for control systems for energy transfer. For example, a building may have numerous energy sources, including solar, wind, grid-based electrical, batteries, on-site generation (e.g., by diesel or gas), etc. and may have many operations it can perform, including manufacturing, computation, temperature control, etc. The techniques herein may be used to control when certain types of energy are used and when certain energy consuming processes are engaged. For example, on sunny days, roof-mounted solar cells may provide enough low-cost power that grid-based electrical power is discontinued during a particular time period while costly manufacturing processes are engaged. On windy, rainy days, the overhead of running solar panels may overshadow the energy provided, but power purchased from a wind-generation farm may be cheap, and only essential energy consuming manufacturing processes and maintenance processes are performed.

In some embodiments, processes 100, 400 may include determining (e.g., in response to a request) the surprisal and/or conviction of one or more data elements or aspects of the energy transfer system. The surprisal for the one or more energy transfer system data elements or aspects may be determined and a determination may be made whether to select or include the one or more energy transfer system data elements or aspects in energy control computer-based reasoning model based on the determined surprisal and/or conviction. While there are more sets of one or more energy transfer system data elements or aspects to assess, the process may return to determine whether more energy transfer system data elements or aspects should be included. Once there are no more energy transfer system data elements or aspects to consider, the process can turn to controlling or causing control of the energy transfer system using the energy control computer-based reasoning model.

In some embodiments, process 100 may determine (e.g., in response to a request) an improved dataset for use in the energy transfer computer-based reasoning model. Based on a model that uses the improved dataset, the process can cause control of an energy transfer system using process 400. For example, if the data elements are related to energy transfer system actions, then the energy control computer-based reasoning model trained on that data will control energy transfer system. Process 400 proceeds by receiving 410 an energy control computer-based reasoning model. The process proceeds by receiving 420 a context. The energy control computer-based reasoning model is then used to determine 430 an action to take. The action is then performed by the control system (e.g., caused by the energy control computer-based reasoning system). If there are more 450 contexts to consider, then the system returns to receive 410 those contexts and otherwise ceases 460. In such embodiments, the energy control computer-based reasoning model may be used to control energy. The chosen actions are then performed by a control system.

### Health Care Decision Making, Prediction, and Fraud Protection

The processes 100, 400 may also be used for health care decision making, prediction (such as outcome prediction), and fraud detection. For example, some health insurers require pre-approval, pre-certification, pre-authorization, and/or reimbursement for certain types of healthcare procedures, such as healthcare services, administration of drugs, surgery, hospital visits, etc. When analyzing pre-approvals, a health care professional must contact the insurer to obtain their approval prior to administering care, or else the health insurance company may not cover the procedure. Not all services require pre-approval, but many may, and which require it can differ among insurers. Health insurance companies may make determinations including, but not necessarily limited to, whether a procedure is medically necessary, whether it is duplicative, whether it follows currently-accepted medical practice, whether there are anomalies in the care or its procedures, whether there are anomalies or errors with the health care provider or professional, etc.

In some embodiments, a health insurance company may have many “features” of data on which health care pre-approval or reimbursement decisions are determined by human operators. These features may include diagnosis information, type of health insurance, requesting health care professional and facility, frequency and/or last claim of the particular type, etc. The data on previous decisions can be used to train the computer-based reasoning system. The techniques herein may be used to guide the health care decision making process. For example, when the computer-based reasoning model determines, with high conviction or confidence, that a procedure should be pre-approved or reimbursed, it may pre-approve or reimburse the procedure without further review. In some embodiments, when the computer-based reasoning model has low conviction re whether or not to pre-approve a particular procedure, it may flag it for human review (including, e.g., sending it back to the submitting organization for further information). In some embodiments, some or all of the rejections of procedure pre-approval or reimbursement may be flagged for human review.

Further, in some embodiments, the techniques herein can be used to flag trends, anomalies, and/or errors. For example, as explained in detail elsewhere herein, the techniques can be used to determine, for example, when there are anomalies for a request for pre-approval, diagnoses, reimbursement requests, etc. with respect to the computer-based reasoning model trained on prior data. When the anomaly is detected, (e.g., outliers, such as a procedure or prescription has been requested outside the normal range of occurrences per time period, for an individual that is outside the normal range of patients, etc.; and/or what may be referred to as “inliers”—or “contextual outliers,” such as too frequently (or rarely) occurring diagnoses, procedures, prescriptions, etc.), the pre-approval, diagnosis, reimbursement request, etc. can be flagged for further review. In some cases, these anomalies could be errors (e.g., and the health professional or facility may be contacted to rectify the error), acceptable anomalies (e.g., patients that need care outside of the normal bounds), or unacceptable anomalies. Additionally, in some embodiments, the techniques herein can be used to determine and flag trends (e.g., for an individual patient, set of patients, health department or facility, region, etc.). The techniques herein may be useful not only because they can automate and/or flag pre-approval decision, reimbursement requests, diagnosis, etc., but also because the trained computer-based reasoning model may contain information (e.g., prior decision) from multiple (e.g., 10 s, 100 s, 1000 s, or more) prior decision makers. Consideration of this large amount of information may be untenable for other approaches, such as human review.

The techniques herein may also be used to predict adverse outcomes in numerous health care contexts. The computer-based reasoning model may be trained with data from previous adverse events, and perhaps from patients that did not have adverse events. The trained computer-based reasoning system can then be used to predict when a current or prospective patient or treatment is likely to cause an adverse event. For example, if a patient arrives at a hospital, the patient's information and condition may be assessed by the computer-based reasoning model using the techniques herein in order to predict whether an adverse event is probable (and the conviction of that determination). As a more specific example, if a septuagenarian with a history of low blood pressure is admitted for monitoring a heart murmur, the techniques herein may flag that patient for further review. In some embodiments, the determination of a potential adverse outcome may be an indication of one or more possible adverse events, such as a complication, having an additional injury, sepsis, increased morbidity, and/or getting additionally sick, etc. Returning to the example of the septuagenarian with a history of low blood pressure, the techniques herein may indicate that, based on previous data, the possibility of a fall in the hospital is unduly high (possibly with high conviction). Such information can allow the hospital to try to ameliorate the situation and attempt to prevent the adverse event before it happens.

In some embodiments, the techniques herein include assisting in diagnosis and/or diagnosing patients based on previous diagnosis data and current patient data. For example, a computer-based reasoning model may be trained with previous patient data and related diagnoses using the techniques herein. The diagnosis computer-based reasoning model may then be used in order to suggest one or more possible diagnoses for the current patient. As a more specific example, a septuagenarian may present with specific attributes, medical history, family history, etc. This information may be used as the input context to the diagnosis computer-based reasoning system, and the diagnosis computer-based reasoning system may determine one or more possible diagnoses for the septuagenarian. In some embodiments, those possible diagnoses may then be assessed by medical professionals. The techniques herein may be used to diagnose any condition, including, but not limited to breast cancer, lung cancer, colon cancer, prostate cancer, bone metastases, coronary artery disease, congenital heart defect, brain pathologies, Alzheimer's disease, and/or diabetic retinopathy.

In some embodiments, processes 100, 400 may include determining (e.g., in response to a request) the surprisal and/or conviction of one or more data elements or aspects of the health care system. The surprisal or conviction for the one or more health care system data elements or aspects may be determined and a determination may be made whether to select or include the one or more health care system data elements or aspects in a health care system computer-based reasoning model based on the determined surprisal and/or conviction. While there are more sets of one or more health care system data elements or aspects to assess, the process may return to determine whether more health care system data elements or aspects should be included. Once there are no more health care system data elements or aspects to consider included in the model, the process can turn to controlling or causing control of the health care computer-based reasoning system using the health care system computer-based reasoning model.

In some embodiments, process 100 may determine (e.g., in response to a request) an improved dataset for use in the health care system computer-based reasoning model. Based on a model that uses the improved dataset, the process can cause control of a health care computer-based reasoning system using process 400. For example, if the data elements are related to health care system actions, then the health care system computer-based reasoning model trained on that data will control the health care system. Process 400 proceeds by receiving 410 a health care system computer-based reasoning model. The process proceeds by receiving 420 a context. The health care system computer-based reasoning model is then used to determine 430 an action to take. The action is then performed by the control system (e.g., caused by the health care system computer-based reasoning system). If there are more 450 contexts to consider, then the system returns to receive 410 those contexts and otherwise ceases 460. In such embodiments, the health care system computer-based reasoning model may be used to assess health care decisions, predict outcomes, etc. In some embodiments, the chosen action(s) are then performed by a control system.

### Financial Decision Making, Prediction, and Fraud Protection

The processes 100 and/or 400 may also be used for financial decision making, prediction (such as outcome or performance prediction), and/or fraud detection. For example, some financial systems require approval, certification, authorization, and/or reimbursement for certain types of financial transactions, such as loans, lines of credit, credit or charge approvals, etc. When analyzing approvals, a financial professional may determine, as one example, whether to approve prior to loaning money. Not all services or transactions require approval, but many may, and which require it can differ among financial system or institutions. Financial transaction companies may make determinations including, but not necessarily limited to, whether a loan appears to be viable, whether a charge is duplicative, whether a loan, charge, etc. follows currently-accepted practice, whether there are anomalies associated with the loan or charge, whether there are anomalies or errors with the any party to the loan, etc.

In some embodiments, a financial transaction company may have many “features” of data on which financial system decisions are determined by human operators. These features may include credit score, type of financial transaction (loan, credit card transaction, etc.), requesting financial system professional and/or facility (e.g., what bank, merchant, or other requestor), frequency and/or last financial transaction of the particular type, etc. The data on previous decisions can be used to train the computer-based reasoning system. The techniques herein may be used to guide the financial system decision making process. For example, when the computer-based reasoning model determines, with high conviction or confidence, that a financial transaction should be approved (e.g., with high conviction), it may the approve the transaction without further review (e.g., by a human operator). In some embodiments, when the computer-based reasoning model has low conviction re whether or not to approve a particular transaction, it may flag it for human review (including, e.g., sending it back to the submitting organization for further information or analysis). In some embodiments, some or all of the rejections of approvals may be flagged for human review.

Further, in some embodiments, the techniques herein can be used to flag trends, anomalies, and/or errors. For example, as explained in detail elsewhere herein, the techniques can be used to determine, for example, when there are anomalies for a request for approval, etc. with respect to the computer-based reasoning model trained on prior data. When the anomaly is detected, (e.g., outliers, such as a transaction has been requested outside the normal range of occurrences per time period, for an individual that is outside the normal range of transactions or approvals, etc.; and/or what may be referred to as “inliers”—or “contextual outliers,” such as too frequently (or rarely) occurring types of transactions or approvals, unusual densities or changes to densities of the data, etc.), the approval may be flagged for further review. In some cases, these anomalies could be errors (e.g., and the financial professional or facility may be contacted to rectify the error), acceptable anomalies (e.g., transactions or approvals are legitimate, even if outside of the normal bounds), or unacceptable anomalies. Additionally, in some embodiments, the techniques herein can be used to determine and flag trends (e.g., for an individual customer or financial professional, set of individuals, financial department or facility, systems, etc.). The techniques herein may be useful not only because they can automate and/or flag approval decisions, transactions, etc., but also because the trained computer-based reasoning model may contain information (e.g., prior decision) from multiple (e.g., 10 s, 100 s, 1000 s, or more) prior decision makers. Consideration of this large amount of information may be untenable for other approaches, such as human review.

In some embodiments, processes 100 and/or 400 may include determining (e.g., in response to a request) the surprisal and/or conviction of one or more data elements or aspects of the financial system. The surprisal and/or conviction for the one or more financial system data elements or aspects may be determined and a determination may be made whether to select or include the one or more financial system data elements or aspects in a financial system computer-based reasoning model based on the determined surprisal and/or conviction. While there are more sets of one or more financial system data elements or aspects to assess, the process may return to determine whether more financial system data elements or aspects should be included. Once there are no more financial system data elements or aspects to consider included in the model, the process can turn to controlling or causing control of the financial system computer-based reasoning system using the financial system computer-based reasoning model.

In some embodiments, processes 100 and/or 400 may determine (e.g., in response to a request) an improved dataset in the computer-based reasoning model for use in the financial system computer-based reasoning model. Based on a model that uses the improved dataset, the process can cause control of a financial system computer-based reasoning system using process 400. For example, if the data elements are related to financial system actions, then the financial system computer-based reasoning model trained on that data will control the financial system. Process 400 proceeds by receiving 410 a financial system computer-based reasoning model. The process proceeds by receiving 420 a context. The financial system computer-based reasoning model is then used to determine 430 an action to take. The action is then performed by the control system (e.g., caused by the financial system computer-based reasoning system). If there are more 450 contexts to consider, then the system returns to receive 410 those contexts and otherwise ceases 460. In such embodiments, the financial system computer-based reasoning model may be used to assess financial system decisions, predict outcomes, etc. In some embodiments, the chosen action(s) are then performed by a control system.

### Real Estate Future Value and Valuation Prediction

The techniques herein may also be used for real estate value estimation. For example, the past values and revenue from real estate ventures may be used as training data. This data may include, in addition to value (e.g., sale or resale value), compound annual growth rate (“CAGR”), zoning, property type (e.g., multifamily, Office, Retail, Industrial), adjacent business and types, asking rent (e.g., rent per square foot (“sqft”) for each of Office, Retail, Industrial, etc. and/or per unit (for multifamily buildings), further, this may be based on all properties within the selected property type in a particular geography, for example), capitalization rate (or “cap rate” based on all properties within selected property type in a geography), demand (which may be quantified as occupied stock), market capitalization (e.g., an average modeled price per sqft multiplied by inventory sqft of the given property type and/or in a given geography), net absorption (net change in demand for a rolling 12 month period), net completions (e.g., net change in inventory sqft (Office, Retail, Industrial) or units (Multifamily) for a period of time, such as analyzed data element(s) rolling 12 month period), occupancy (e.g., Occupied sqft/total inventory sqft, 100%—vacancy %, etc.), stock (e.g., inventory square footage (Office, Retail, Industrial) or units (Multifamily), revenue (e.g., revenue generated by renting out or otherwise using a piece of real estate), savings (e.g., tax savings, depreciation), costs (e.g., taxes, insurance, upkeep, payments to property managers, costs for findings tenants, property managers, etc.), geography and geographic location (e.g., views of water, distance to shopping, walking score, proximity to public transportation, distance to highways, proximity to job centers, proximity to local universities, etc.), building characteristics (e.g., date built, date renovated, etc.), property characteristics (e.g., address, city, state, zip, property type, unit type(s), number of units, numbers of bedrooms and bathrooms, square footage(s), lot size(s), assessed value(s), lot value(s), improvements value(s), etc.—possibly including current and past values), real estate markets characteristics (e.g., local year-over-year growth, historical year-over-year growth), broader economic information (e.g., gross domestic product growth, consumer sentiment, economic forecast data), local economic information (e.g., local economic growth, average local salaries and growth, etc.), local demographics (e.g., numbers of families, couples, single people, number of working-age people, numbers or percentage of people with at different education, salary, or savings levels, etc.). The techniques herein may be used to train a real estate computer-based reasoning model based on previous properties. Once the real estate computer-based reasoning system has been trained, then input properties may be analyzed using the real estate reasoning system. Using the techniques herein, the surprisal and/or conviction of the training data can be used to build a real estate computer-based reasoning system that balances the size of the computer-based reasoning model with the information that each additional property record (or set of records) provides to the model.

The techniques herein may be used to predict performance of real estate in the future. For example, based on the variables associated discussed here, that are related, e.g., with various geographies, property types, and markets, the techniques herein may be used to find property types and geographies with the highest expected value or return (e.g., as CAGR). As a more specific example, a model of historical CAGR with asking rent, capitalization rate, demand, net absorption, net completions, occupancy, stock, etc. can be trained. That model may be used, along with more current data, to predict the CAGR of various property types and/or geographies over the coming X years (e.g., 2, 3, 5, or 10 years). Such information may be useful for predicting future value for properties and/or automated decision making.

As another example, using the techniques herein, a batch of available properties may be given as input to the real estate computer-based reasoning systems, and the real estate computer-based reasoning system may be used to determine what properties are likely to be good investments. In some embodiments, the predictions of the computer-based reasoning system may be used to purchase properties. Further, as discussed extensively herein, explanations may be provided for the decisions. Those explanation may be used by a controllable system to make investment decisions and/or by a human operator to review the investment predictions.

In some embodiments, processes 100, 400 may include determining the surprisal and/or conviction of each input real estate data case (or multiple real estate data cases) with respect to the associated labels or of the aspects of the computer-based reasoning model. The surprisal and/or conviction for the one or more real estate data cases may be determined and a determination may be made whether to select or include the one or more real estate data cases in the real estate computer-based reasoning model based on the determined surprisal and/or conviction. While there are more sets of one or more real estate data cases to assess, the process may return to determine whether more real estate data case sets should be included or whether aspects should be included and/or changed in the model. Once there are no more training cases to consider, the process can turn to controlling or causing control of predicting real estate investments information for possible use in purchasing real estate using the real estate computer-based reasoning.

In some embodiments, process 100 may determine (e.g., in response to a request) an improved dataset for use in the real estate system computer-based reasoning model. Based on a model that uses the improved dataset, the process can cause control of a real estate system, using, for example, process 400. For example, the training data elements are related to real estate, and the real estate computer-based reasoning model trained on that data will determine investment value(s) for real estate data cases (properties) under consideration. These investment values may be any appropriate value, such as CAGR, monthly income, resale value, income or resale value based on refurbishment or new development, net present value of one or more of the preceding, etc. In some embodiments, process 400 begins by receiving 410 a real estate computer-based reasoning model. The process proceeds by receiving 420 properties under consideration for labeling and/or predicting value(s) for the investment opportunity. The real estate computer-based reasoning model is then used to determine 430 values for the real estate under consideration. The prediction(s) for the real estate is (are) then made 440. If there are more 450 properties to consider, then the system returns to receive 410 data on those properties and otherwise ceases 460. In some embodiments, the real estate computer-based reasoning model may be used to determine which training properties are “closest” (or most similar) to the incoming property or property types and/or geographies predicted as high value. The investment value(s) for the properties under consideration may then be determined based on the “closest” properties or property types and/or geographies.

### Cybersecurity

The processes 100, 400 may also be used for cybersecurity analysis. For example, a cybersecurity company or other organization may want to perform threat (or anomalous behavior) analysis, and in particular may want explanation data associated with the threat or anomalous behavior analysis (e.g., why was a particular event, user, etc. identified as a threat or not a threat?). The computer-based reasoning model may be trained using known threats/anomalous behavior and features associated with those threats or anomalous behavior,. Data that represents neither a threat nor anomalous behavior (e.g., non-malicious access attempts, non-malicious emails, etc.) may also be used to train the computer-based reasoning model. In some embodiments, when a new entity, user, packet, payload, routing attempt, access attempt, log file, etc. is ready for assessment, the features associated with that new entity, user, packet, payload, routing attempt, access attempt, log file, etc. may be used as input in the trained cybersecurity computer-based reasoning system. The cybersecurity computer-based reasoning system may then determine the likelihood that the entity, user, packet, payload, routing attempt, access attempt, pattern in the log file, etc. is or represents a threat or anomalous behavior. Further, explanation data, such as a conviction measures, training data used to make a decision etc., can be used to mitigate the threat or anomalous behavior and/or be provided to a human operator in order to further assess the potential threat or anomalous behavior.

Any type of cybersecurity threat or anomalous behavior can be analyzed and detected, such as denial of service (DoS), distributed DOS (DDoS), brute-force attacks (e.g., password breach attempts), compromised credentials, malware, insider threats, advanced persistent threats, phishing, spear phishing, etc. and/or anomalous traffic volume, bandwidth use, protocol use, behavior of individuals and/or accounts, logfile pattern, access or routing attempt, etc. In some embodiments the cybersecurity threat is mitigated (e.g., access is suspended, etc.) while the threat is escalated to a human operator. As a more specific example, if an email is received by the email server, the email may be provided as input to the trained cybersecurity computer-based reasoning model. The cybersecurity computer-based reasoning model may indicate that the email is a potential threat (e.g., detecting and then indicating that email includes a link to a universal resource locator that is different from the universal resource location displayed in the text of the email). In some embodiments, this email may be automatically deleted, may be quarantined, and/or flagged for review.

In some embodiments, processes 100, 400 may include determining (e.g., in response to a request) the surprisal and/or conviction of one or more data elements or aspects of the cybersecurity system. The surprisal or conviction for the one or more cybersecurity system data elements or aspects may be determined and a determination may be made whether to select or include the one or more cybersecurity system data elements or aspects in a cybersecurity system computer-based reasoning model based on the determined surprisal and/or conviction. While there are more sets of one or more cybersecurity system data elements or aspects to assess, the process may return to determine whether more cybersecurity system data elements or aspects should be included. Once there are no more cybersecurity system data elements or aspects to consider, the process can turn to controlling or causing control of the cybersecurity computer-based reasoning system using the cybersecurity system computer-based reasoning model.

In some embodiments, process 100 may determine (e.g., in response to a request) an improved dataset for use in the cybersecurity system computer-based reasoning model. Based on a model that uses the improved dataset, the process can cause control of a cybersecurity computer-based reasoning system using process 400. For example, if the data elements are related to cybersecurity system actions, then the cybersecurity system computer-based reasoning model trained on that data will control the cybersecurity system (e.g., quarantine, delete, or flag for review, entities, data, network traffic, etc.). Process 400 proceeds by receiving 410 a cybersecurity system computer-based reasoning model. The process proceeds by receiving 420 a context. The cybersecurity system computer-based reasoning model is then used to determine 430 an action to take. The action is then performed by the control system (e.g., caused by the cybersecurity system computer-based reasoning system). If there are more 450 contexts to consider, then the system returns to receive 410 those contexts and otherwise ceases 460. In such embodiments, the cybersecurity system computer-based reasoning model may be used to assess cybersecurity threats, etc. In some embodiments, the chosen action(s) are then performed by a control system.

### Example Control Hierarchies

In some embodiments, the technique herein may use a control hierarchy to control systems and/or cause actions to be taken (e.g., as part of controlling or causing control of, or causing 440 performance in FIG. 5 and FIG. 4). There are numerous example control hierarchies and many types of systems to control, and hierarchy for vehicle control is presented below. In some embodiments, only a portion of this control hierarchy is used. It is also possible to add levels to (or remove levels from) the control hierarchy.

An example control hierarchy for controlling a vehicle could be:
Primitive Layer—Active vehicle abilities (accelerate, decelerate), lateral, elevation, and orientation movements to control basic vehicle navigation
Behavior Layer—Programmed vehicle behaviors which prioritize received actions and directives and prioritize the behaviors in the action.
Unit Layer—Receives orders from command layer, issues moves/directives to the behavior layer.
Command Layers (hierarchical)—Receives orders and gives orders to elements under its command, which may be another command layer or unit layer.

### Example Data Cases, Data Elements, Contexts, and Operational Situations

In some embodiments, the cases, data cases, or data elements may include context data and action data in context-action pairs. Various embodiments discussed herein may include any of the context data and actions associated with control of systems. For example, context data may include the state of machines and/or sensors in a manufacturing plant and the actions may include control of parts of the manufacturing system (e.g., speed of certain machinery, turning machinery on or off, signaling something for operator review, etc.). Further, cases may relate to control of a vehicle, control of a smart voice control, health system, real estate system, image labelling systems, or any of the other examples herein. For example, context data may include data related to the operation of the vehicle, including the environment in which it is operating, and the actions taken may be of any granularity. Consider an example of data collected while a driver, Alicia, drives around a city. The collected data could be context and action data where the actions taken can include high-level actions (e.g., drive to next intersection, exit the highway, take surface roads, etc.), mid-level actions (e.g., turn left, turn right, change lanes) and/or low-level actions (e.g., accelerate, decelerate, etc.). The contexts can include any information related to the vehicle (e.g. time until impact with closest object(s), speed, course heading, breaking distances, vehicle weight, etc.), the driver (pupillary dilation, heart rate, attentiveness, hand position, foot position, etc.), the environment (speed limit and other local rules of the road, weather, visibility, road surface information, both transient such as moisture level as well as more permanent, such as pavement levelness, existence of potholes, etc.), traffic (congestion, time to a waypoint, time to destination, availability of alternate routes, etc.), and the like. These input data (e.g., context-action pairs for training a context-based reasoning system or input training contexts with outcome actions for training a machine learning system) can be saved and later used to help control a compatible vehicle in a compatible operational situation. The operational situation of the vehicle may include any relevant data related to the operation of the vehicle. In some embodiments, the operational situation may relate to operation of vehicles by particular individuals, in particular geographies, at particular times, and in particular conditions. For example, the operational situation may refer to a particular driver (e.g., Alicia or Carole). Alicia may be considered a cautious car driver, and Carole a faster driver. As noted above, and in particular, when approaching a stop sign, Carole may coast in and then brake at the last moment, while Alicia may slow down earlier and roll in. As another example of an operational situation, Bob may be considered the “best pilot” for a fleet of helicopters, and therefore his context and actions may be used for controlling self-flying helicopters.

In some embodiments, the operational situation may relate to the environment in which the system is operating. In the vehicle context, the locale may be a geographic area of any size or type, and may be determined by systems that utilize machine learning. For example, an operational situation may be “highway driving” while another is “side street driving”. An operational situation may be related to an area, neighborhood, city, region, state, country, etc. For example, one operational situation may relate to driving in Raleigh, NC and another may be driving in Pittsburgh, PA. An operational situation may relate to safe or legal driving speeds. For example, one operational situation may be related to roads with forty-five miles per hour speed limits, and another may relate to turns with a recommended speed of 20 miles per hour. The operational situation may also include aspects of the environment such as road congestion, weather or road conditions, time of day, etc. The operational situation may also include passenger information, such as whether to hurry (e.g., drive faster), whether to drive smoothly, technique for approaching stop signs, red lights, other objects, what relative velocity to take turns, etc. The operational situation may also include cargo information, such as weight, hazardousness, value, fragility of the cargo, temperature sensitivity, handling instructions, etc.

In some embodiments, the context and action may include system maintenance information. In the vehicle context, the context may include information for timing and/or wear-related information for individual or sets of components. For example, the context may include information on the timing and distance since the last change of each fluid, each belt, each tire (and possibly when each was rotated), the electrical system, interior and exterior materials (such as exterior paint, interior cushions, passenger entertainment systems, etc.), communication systems, sensors (such as speed sensors, tire pressure monitors, fuel gauges, compasses, global positioning systems (GPS), RADARs, LiDARs, cameras, barometers, thermal sensors, accelerometers, strain gauges, noise/sound measurement systems, etc.), the engine(s), structural components of the vehicle (wings, blades, struts, shocks, frame, hull, etc.), and the like. The action taken may include inspection, preventative maintenance, and/or a failure of any of these components. As discussed elsewhere herein, having context and actions related to maintenance may allow the techniques to predict when issues will occur with future vehicles and/or suggest maintenance. For example, the context of an automobile may include the distance traveled since the timing belt was last replaced. The action associated with the context may include inspection, preventative replacement, and/or failure of the timing belt. Further, as described elsewhere herein, the contexts and actions may be collected for multiple operators and/or vehicles. As such, the timing of inspection, preventative maintenance and/or failure for multiple automobiles may be determined and later used for predictions and messaging.

Causing performance of an identified action can include causing a control system to control the target system based on the identified action. In the self-controlled vehicle context, this may include sending a signal to a real car, to a simulator of a car, to a system or device in communication with either, etc. Further, the action to be caused can be simulated/predicted without showing graphics, etc. For example, the techniques might cause performance of actions in the manner that includes, determining what action would be take, and determining whether that result would be anomalous, and performing the techniques herein based on the determination that such state would be anomalous based on that determination, all without actually generating the graphics and other characteristics needed for displaying the results needed in a graphical simulator (e.g., a graphical simulator might be similar to a computer game).

Numerous other examples of cases, data, contexts and actions are discussed herein.

### Example of Certainty and Conviction

In some embodiments, certainty score is a broad term encompassing it plain and ordinary meaning, including the certainty (e.g., as a certainty function) that a particular set of data fits a model, the confidence that a particular set of data conforms to the model, or the importance of a feature or case with regard to the model. Determining a certainty score for a particular case can be accomplished by removing the particular case from the case-based or computer-based reasoning model and determining the conviction score of the particular case based on an entropy measure associated with adding that particular case back into the model. Any appropriate entropy measure, variance, confidence, and/or related method can be used for making this determination, such as the ones described herein. In some embodiments, certainty or conviction is determined by the expected information gain of adding the case to the model divided by the actual information gain of adding the case. For example, in some embodiments, certainty or conviction may be determined based on Shannon Entropy, Rényi entropy, Hartley entropy, min entropy, Collision entropy, Rényi divergence, diversity index, Simpson index, Gini coefficient, Kullback-Leibler divergence, Fisher information, Jensen-Shannon divergence, Symmetrised divergence. In some embodiments, certainty scores are conviction scores and are determined by calculating the entropy, comparing the ratio of entropies, and/or the like.

In some embodiments, the conviction of a case may be computed based on looking only at the K nearest neighbors when adding the feature back into the model. The K nearest neighbors can be determined using any appropriate distance measure, including use of Euclidean distance, 1—Kronecker delta, Minkowski distance, Damerau-Levenshtein distance, and/or any other distance measure, metric, pseudometric, premetric, index, or the like. In some embodiments, influence functions are used to determine the importance of a feature or case.

In some embodiments, determining certainty or conviction scores can include determining the conviction of each feature of multiple features of the cases in the computer-based reasoning model. In this context the word “feature” is being used to describe a data field as across all or some of the cases in the computer-based reasoning model. The word “field,” in this context, is being used to describe the value of an individual case for a particular feature. For example, a feature for a theoretical computer-based reasoning model for self-driving cars may be “speed”. The field value for a particular case for the feature of speed may be the actual speed, such as thirty-five miles per hour.

Returning to determining certainty or conviction scores, in some embodiments, determining the conviction of a feature may be accomplished by removing the feature from the computer-based reasoning model and determining a conviction score of the feature based on an entropy measure associated with adding the feature back into the computer-based reasoning model. For example, returning to the example above, removing a speed feature from a self-driving car computer-based reasoning model could include removing all of the speed values (e.g., fields) from cases from the computer-based reasoning model and determining the conviction of adding speed back into the computer-based reasoning model. The entropy measure used to determine the conviction score for the feature can be any appropriate entropy measure, such as those discussed herein. In some embodiments, the conviction of a feature may also be computed based on looking only at the K nearest neighbors when adding the feature back into the model. In some embodiments, the feature is not actually removed, but only temporarily excluded.

### Hardware Overview

According to some embodiments, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

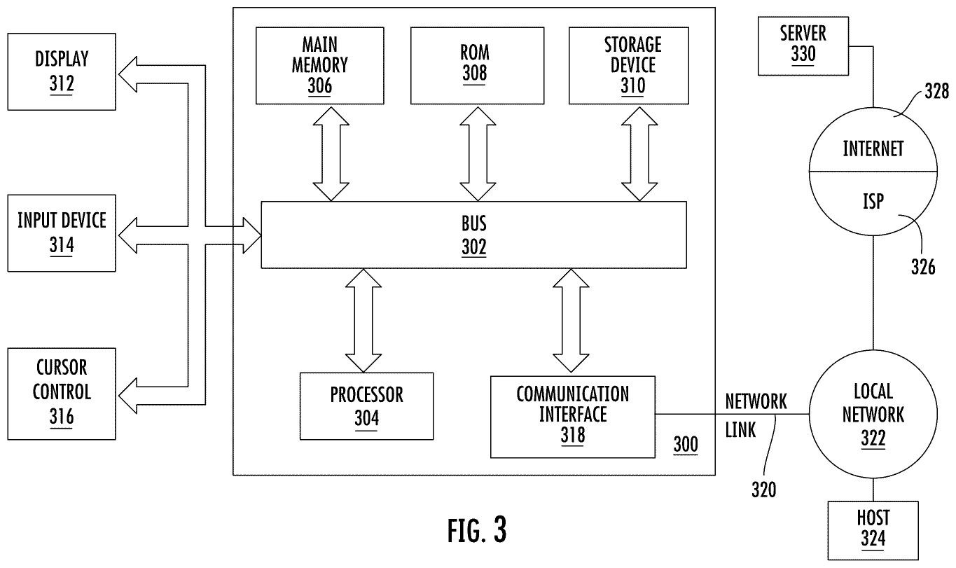

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general-purpose microprocessor.

Computer system 300 also includes a main memory 306, such as a random-access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as an OLED, LED or cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane. The input device 314 may also have multiple input modalities, such as multiple 2-axes controllers, and/or input buttons or keyboard. This allows a user to input along more than two dimensions simultaneously and/or control the input of more than one type of action.

Computer system 300 may implement the techniques described herein using customized hard-wired logic, one or more ASICs or FPGAs, firmware and/or program logic which in combination with the computer system causes or programs computer system 300 to be a special-purpose machine. According to some embodiments, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information. Such a wireless link could be a Bluetooth, Bluetooth Low Energy (BLE), 802.11 WiFi connection, or the like.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the worldwide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method for improved feature analysis, the method comprising:
obtaining, by a computing system comprising one or more computing devices, a dataset comprising a plurality of cases, wherein each of the plurality of cases has a plurality of values respectively for a plurality of features;
evaluating, by the computing system based on the dataset, a feature importance metric for a plurality of feature subsets of the plurality of features to respectively generate a plurality of feature importance values, wherein the feature importance value for each feature subset indicates an importance of the feature subset in predicting another feature subset;
generating, by the computing system, a feature importance matrix from the plurality of feature importance values, wherein the feature importance matrix comprises a square matrix with row and column labels equal to the plurality of feature subsets; and
identifying, by the computing system, one or more asymmetries exhibited by the feature importance matrix.

2. The computer-implemented method of claim 1, wherein the feature importance metric comprises a feature contribution metric.

3. The computer-implemented method of claim 1, wherein the feature importance metric comprises a mean decrease in accuracy metric.

4. The computer-implemented method of claim 1, further comprising generating, by the computing system, a graphical user interface visualization based on the asymmetries identified from the feature importance matrix.

5. The computer-implemented method of claim 4, wherein the graphical user interface visualization comprises a directed graph, and wherein the directed graph comprises two or more nodes that correspond to two or more of the feature subsets, and wherein the directed graph comprises one or more directed edges that each demonstrate a directional relationship between two of the feature subsets that correspond to two of nodes, each directional relationship derived from one of the one or more asymmetries.

6. The computer-implemented method of claim 4, wherein the graphical user interface visualization comprises a matrix visualization of at least a portion of the feature importance matrix, wherein the matrix visualization comprises a visual characteristic that identifies the one or more asymmetries.

7. The computer-implemented method of claim 4, wherein the graphical user interface
visualization comprises a quadrant visualization that sorts at least some of the plurality of feature subsets into four quadrants, the four quadrants corresponding to:
high reduction in uncertainty but low importance;
low reduction in uncertainty and low importance;
low reduction in uncertainty but high importance; and
high reduction in uncertainty and high importance.

8. The computer-implemented method of claim 1, wherein said steps of evaluating, generating, and identifying are performed for each of multiple different feature importance metrics.

9. The computer-implemented method of claim 1, wherein:
generating, by the computing system, the feature importance matrix from the plurality of feature importance values comprises normalizing, by the computing system, the plurality of feature importance values; and
normalizing, by the computing system, the plurality of feature importance values comprises:
normalizing, by the computing system, the plurality of feature importance values by a contribution to a percentage of an overall prediction; or
normalizing, by the computing system, the plurality of feature importance values between a mean absolute deviation of the feature subset and a residual of predicting the feature subset given all of the dataset.

10. The computer-implemented method of claim 1, wherein the plurality of feature subsets comprise all feature subsets contained in a superset generated from the plurality of features.

11. The computer-implemented method of claim 1, wherein the plurality of feature subsets equal the plurality of features.

12. The computer-implemented method of claim 1, further comprising automatically generating, by the computing system, one or more feature correction actions based on the one or more asymmetries.

13. The computer-implemented method of claim 12, further comprising automatically performing, by the computing system, the one or more feature correction actions on the dataset.

14. The computer-implemented method of claim 13, further comprising, after performing the one or more feature correction actions, training or re-training, by the computing system, a machine-learned model on the dataset.

15. The computer-implemented method of claim 1, further comprising:
identifying, by the computing system, a causal relationship between one or more of the feature subsets and a current state of a controllable system based on the one or more asymmetries; and
controlling, by the computing system, the controllable system based on the causal relationship.

16. The computer-implemented method of claim 1, further comprising identifying, by the computing system, one or more graph structures exhibited by the feature importance matrix, wherein the one or more graph structures comprise one or more cliques, ergodic regions, or transitive regions.

17. The computer-implemented method of claim 1, further comprising identifying, by the computing system, one or more graph metric exhibited by the feature importance matrix, wherein the one or more graph metrics comprise one or more measurements of centrality, assortativity, or modularity.

18. The computer-implemented method of claim 1, wherein said steps of evaluating, generating, and identifying are performed for both a feature contributions metric and a mean decrease in accuracy metric.

19. A computing system for improved feature analysis, the system comprising:
one or more processors; and
one or more non-transitory computer-readable media storing instructions that, when executed by the one or more processors, cause the system to perform operations comprising:
obtaining a dataset comprising a plurality of cases, wherein each of the plurality of cases has a plurality of values respectively for a plurality of features;
for a target feature subset of a plurality of feature subsets, evaluating a feature importance value by:
determining a first predictive accuracy for the target feature subset based on a first set of input features that includes the target feature subset;
determining a second predictive accuracy for the target feature subset based on a second set of input features that excludes the target feature subset; and
generating the feature importance value for the target feature subset based on a comparison of the first predictive accuracy and the second predictive accuracy;
generating a feature importance matrix from a plurality of feature importance values evaluated for the plurality of feature subsets; and
identifying one or more asymmetries exhibited by the feature importance matrix.

20. The computing system of claim 19, wherein the operations further comprise:
identifying, based on a magnitude of the feature importance value for the target feature subset, an indication that one or more unobserved features relevant to predicting the target feature subset are absent from the dataset.

21. The computing system of claim 20, wherein the operations further comprise:
generating, in response to identifying the indication, a feature correction action comprising a recommendation to obtain additional data for one or more new features related to the target feature subset.

22. The computing system of claim 19, wherein identifying the one or more asymmetries comprises identifying a directional causal relationship between two feature subsets of the plurality of feature subsets.

23. A computing system for improved feature analysis, the computing system comprising:
one or more processors; and
one or more non-transitory computer-readable media storing instructions that, when executed by the one or more processors, cause the system to perform operations comprising:
obtaining a dataset comprising a plurality of cases, wherein each of the plurality of cases has a plurality of values respectively for a plurality of features;
evaluating, for each of a plurality of feature subsets, a missing information ratio by:
determining a best-case predictive accuracy for a target feature subset by predicting the target feature subset using a set of input features that includes the target feature subset;
determining a standard predictive accuracy for the target feature subset by predicting the target feature subset using a set of input features that excludes the target feature subset; and
generating the missing information ratio based on a comparison between the best-case predictive accuracy and the standard predictive accuracy; and
identifying, based on a magnitude of the missing information ratio for the target feature subset, an indication that one or more unobserved features relevant to predicting the target feature subset are absent from the dataset.

24. The computing system of claim 23, wherein the operations further comprise:
generating a feature importance matrix from a plurality of missing information ratios evaluated for the plurality of feature subsets; and
identifying one or more asymmetries exhibited by the feature importance matrix to identify a directional causal relationship between two of the plurality of feature subsets.

25. The computing system of claim 23, wherein the operations further comprise:
generating, in response to identifying the indication, a feature correction action comprising a recommendation to collect additional case data for one or more new features related to the target feature subset.
